(19) United States
(12) Patent Application Publication
(10) Pub. No.: US 2025/0350333 A1
(43) Pub. Date: Nov. 13, 2025

(54) PORT MUTING INDICATION TO UE

(71) Applicant: Telefonaktiebolaget LM Ericsson (publ), Stockholm (SE)

(72) Inventors: Ajit NIMBALKER, Dublin, CA (US); Andres REIAL, Höllviken (SE); Sina MALEKI, Malmö (SE); Ali NADER, Malmö (SE); Pål FRENGER, Linköping (SE); Ilmiawan SHUBHI, Malmö (SE); Siva MURUGANATHAN, Stittsville (CA)

(21) Appl. No.: 18/860,169

(22) PCT Filed: Apr. 28, 2023
(86) PCT No.: PCT/EP2023/061241

§ 371 Date: Oct. 25, 2024

Related U.S. Application Data
(60) Provisional application No. 63/336,717, filed on Apr. 29, 2022.

(51) Int. Cl. H04B 7/06; H04B 17/309; H04W 16/28; H04W 72/231

(52) U.S. Cl. CPC H04B 7/0626; H04B 17/346; H04W 16/28; H04W 72/231

(57) ABSTRACT

A method, system and apparatus are disclosed. A network node is provided which is configured to transmit a first signaling to the WD, the first signaling including a first channel state information reference signal, CSI-RS, measurement configuration, the first CSI-RS measurement configuration indicating a first plurality of ports to measure, transmit of a second signaling to the WD, the second signaling including a CSI-RS port muting pattern indication muting at least one muted port of the first plurality of ports and enabling the WD to utilize a modified CSI-RS measurement configuration for feedback reporting, and, receive, from the WD, at least one CSI-RS measurement report for at least one CSI-RS measurement on at least one port of the plurality of ports using the modified CSI-RS measurement configuration and omitting measurements on the at least one muted port.

### TECHNICAL FIELD

The present disclosure relates to wireless communications, and in particular, to management of communication ports in wireless devices.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, Radio Access Networks (RANs), such as a New Generation Radio Access Network (NG-RAN), broadband communication between network nodes, such as a Next Generation Node B (gNB), and mobile wireless devices (WD), as well as communication between network nodes and between WDs.

### Network Energy Consumption

The network (NW) power consumption for NR may often be lower when compared to LTE, e.g., because of NR's leaner design. In some implementations, however, NR may likely consume more power compared to LTE, e.g., due to the higher bandwidth and introduction of additional elements such as 64 transmit/receive (TX/RX) ports with associated digital radio frequency (RF) chains. As the NW (e.g., a network node) is expected to be able to support WDs with its maximum capability (e.g., throughput, coverage, etc.), the NW (e.g., network node) may need to use full configuration even when the maximum NW support is actually rarely needed by the WDs.

In addition, an increased number of TX/RX ports may also lead to an increase of the number of reference signals (e.g., channel state information reference signal (CSI-RS)) needed to be transmitted by the NW (e.g., network node) (and to be measured by the WD) for a proper signal detection. Thus, the additional TX/RX ports may result in additional power consumption, i.e., to transmit a larger number of CSI-RS to the WDs. Furthermore, it should also be noted that the larger number of CSI-RS transmissions may also consume resources (e.g., valuable NW resources).

### NW Energy Saving by Applying Antenna Muting

To provide high-rate cell-edge coverage and high spatial resolution, an NR network node (e.g., gNB) may deploy large antenna arrays with hundreds of antenna elements and up to 32 ports, for example. The energy cost associated with RF (e.g., power amplifier (PA) and low noise amplifier (LNA)), digital processing/beamforming (BF), and baseband processing associated with such an array may be high. In some scenarios (e.g., few users, low load, reduced user transmit power (TP) or latency requirements), maintaining sufficient user and system performance may not require a full antenna network node (gNB) array. The network node (gNB) may then deactivate or mute parts of the antenna panel and transmit with a subset of antenna elements and transmission ports.

### CSI-RS Multiplexing and Mapping to Physical Resources

In some implementations, a CSI-RS resource may span 1, 2, or 4 orthogonal frequency division multiplex (OFDM) symbols, for example:
One symbol for 1, 2, 4, 8, 12 ports;
Two symbols for 4, 8, 12, 16 ports; and
Four symbols for 24, 32 ports.

A CSI-RS resource may start at any symbol (0-13) within a slot, for example:
Defined by a single start symbol for 1 symbol CSI-RS, 2 symbol CSI-RS, and 4 symbols with T-OCC span 4; and/or
Defined by two start symbol indices in the 4 symbol CSI-RS 2+2 with T-OCC span 2.

Components may be mapped to frequency with granularity of component size, 1, 2, or 4 subcarriers. The same subcarriers may be used across all symbols in a resource, for example.

Resource element (RE) level multiplexing with tracking reference signal (TRS)/demodulation reference signal (DMRS) may be possible in the same OFDM symbol, in some implementations. In some cases, RE level multiplexing with DMRS may not be possible. FIG. 1 is a diagram which illustrates example resource configurations, such as 1, 2, and 4 symbol resources.

### CSI-RS Configuration Options

In some NR systems, the following three types of CSI-RS transmissions may be supported:
Aperiodic CSI-RS Transmission: This is a one-shot CSI-RS transmission that can be triggered by a gNB via DCI in any slot. Here, one-shot means that CSI-RS transmission only happens once per trigger in one slot. The CSI-RS resources (i.e., the resource element locations which consist of subcarrier locations and OFDM symbol locations) for aperiodic CSI-RS are preconfigured to WDs via higher layer signaling. The transmission of aperiodic CSI-RS is triggered via downlink control information (DCI). As shown in Table 1, aperiodic CSI-RS can be used for aperiodic CSI reporting.
Periodic CSI-RS Transmission: These CSI-RS transmissions are preconfigured by higher layer signaling, and the preconfiguration includes parameters such as periodicity and slot offset. Periodic CSI-RS is controlled by higher layer signaling only. That is, the periodic CSI-RS transmission starts following radio resource control (RRC) configuration following the configured parameters. As shown in Table 1, periodic CSI-RS can be used for periodic CSI reporting, semi-persistent CSI reporting and aperiodic CSI reporting.
Semi-Persistent CSI-RS Transmission: Similar to periodic CSI-RS, resources for semi-persistent CSI-RS transmissions are preconfigured via higher layer signaling with parameters such as periodicity and slot offset. However, unlike periodic CSI-RS, a dynamic allocation activation signaling via a medium access control (MAC) control element (CE) is needed to begin transmission of semi-persistent CSI-RS on the preconfigured resources. Furthermore, semi-persistent CSI-RS is transmitted for a limited time duration until the activated semi-persistent CSI-RS is deactivated via a deactivation signaling via a MAC CE. As shown in Table 1, semi-persistent CSI-RS can be used for semi-persistent CSI reporting and aperiodic CSI reporting.

TABLE 1
Triggering/Activation of CSI Reporting for the possible CSI-RS Configurations.

| CSI-RS | Periodic CSI | Semi-Persistent CSI | Aperiodic CSI |
|---|---|---|---|
| Configuration | Reporting | Reporting | Reporting |
| Periodic CSI-RS | No dynamic | For reporting on | Triggered by DCI; |
| | triggering/activation | PUCCH, the WD | additionally, |
| | | receives an | subselection |
| | | activation command, | indication as |
| | | as described in | described in clause |
| | | clause 6.1.3.16 of | 6.1.3.13 of 3GPP |
| | | 3GPP technical | TS 38.321 possible |
| | | specification (TS) | as defined in |
| | | 38.321; for reporting | Clause 5.2.1.5.1. |
| | | on PUSCH, the WD | |
| | | receives triggering | |
| | | on DCI | |
| Semi-Persistent | Not Supported | For reporting on | Triggered by DCI; |
| CSI-RS | | PUCCH, the WD | additionally, |
| | | receives an | subselection |
| | | activation command, | indication as |
| | | as described in | described in clause |
| | | clause 6.1.3.16 of | 6.1.3.13 of 3GPP |
| | | 3GPP TS 38.321; | TS 38.321 possible |
| | | for reporting on | as defined in |
| | | PUSCH, the WD | Clause 5.2.1.5.1. |
| | | receives triggering | |
| | | on DCI | |
| Aperiodic CSI-RS | Not Supported | Not Supported | Triggered by DCI; |
| | | | additionally, |
| | | | subselection |
| | | | indication as |
| | | | described in clause |
| | | | 6.1.3.13 of 3GPP |
| | | | TS 38.321 possible |
| | | | as defined in |
| | | | Clause 5.2.1.5.1. |

When a network node 16 (gNB) chooses to mute a subset of its antennas, depending on the selected CSI-RS transmission format and antenna-to-port mapping, a subset of non-zero power (NZP) CSI-RS ports may end up not transmitting any signals, i.e., any measurement on such ports only reflects noise and interference.

In some solutions, the network node (gNB) may provide a modified CSI-RS configuration to WDs, one configuration for a first number of ports, another for a second number of ports, and so on. This can increase higher layer signaling overhead and WD complexity/capability (e.g., WD supporting increased quantity of CSI-RS resources/resource configurations). Performing the network node (gNB) antenna muting without informing the WD is used in some scenarios.

Such muting may not cause problems for the NW since the network node (gNB) may be aware of which ports are effectively muted. However, in this case, the WD collects extraneous CSI-RS samples and performs measurement computations that do not result in any useful information. For a large number of ports, e.g., 32 ports, the full set of ports are mapped to 4 CSI-RS symbols. If the effectively active ports are limited to 16 ports, it may be that only 2 symbols carry useful information, and if limited to 12 or 8 ports, a single symbol may merit measuring and processing. WDs that are configured to measure and report CSI on a large number of CSI-RS ports may thus operate in an inefficient measurement mode. This leads to unnecessary energy consumption both for RF sampling and for baseband processing. Furthermore, the REs that were initially used for CSI-RS transmission before muting in these 2 symbols of this example could have been used for e.g., data transmission by the NW (i.e., network node) if the WD and the NW (i.e., network node) would have exchanged information about the muting status.

In sum, the processes described above suffer from performing unnecessary CSI-RS measurements, the related wasteful WD energy consumption, low measured CSI quality during port muting scenarios, and the inability to utilize the associated unused REs.

### SUMMARY

Some embodiments advantageously provide methods, systems, and apparatuses for reduction of CSI-RS measurements, related WD energy consumption, and/or improvement of measured CSI quality (e.g., by handling samples corresponding to the muted ports) during actual port muting scenarios and to furthermore enable utilization of associated unused REs for other purposes, such as for data transmission, interference measurements, etc.

In some embodiments, a WD may be configured with a predetermined quantity of CSI-RS ports to measure and/or report. The WD may be further configured with one or more port muting/skipping patterns. During operation, the WD may receive lower-layer signaling, e.g., DCI or MAC CE, indicating whether and which port muting pattern is in effect. The WD may then omit measuring/processing CSI-RS resources corresponding to the muted ports, which may include omitting sampling CSI-RS symbols that carry muted ports (e.g., only muted ports) and/or omitting related estimation processing in baseband. The muting/skipping pattern may be aperiodic or (semi-) periodic.

In some other embodiments, when a muting pattern frees up REs on the resource grid (time/frequency resources), the REs can be configured for other purposes by the NW (i.e., network node).

In one or more embodiments, the principles of the present disclosure may be applied to CSI-RS measurements for beam management (BM), radio link monitoring (RLM), link adaptation (LA), radio resource management (RRM), or other purposes.

In some embodiments, WD processing related to CSI-RS measurements is reduced and without a performance impact when compared to typical processes. The WD can save energy since the WD may omit sampling irrelevant CSI-RS symbols and performing estimation procedures associated with the symbols.

In some other embodiments, NW energy savings are obtained. By having a more efficient method (when compared to typical methods) to adopt CSI-RS transmissions where the currently active CSI-RS configuration can be communicated to the WDs, unnecessary CSI-RS transmissions may be eliminated or reduced, which may result in efficient use of NW energy. Further, resources may be freed (e.g., made available) and/or some ports that are muted may be used for other purposes such as data transmission, interference measurements, etc.

According to a first aspect of the present disclosure, a wireless device, WD, configured to communicate with a network node is provided. The WD includes processing circuitry configured to receive a first signaling from the network node, the first signaling including a first channel state information reference signal, CSI-RS, measurement configuration, the first CSI-RS measurement configuration indicating a first plurality of ports to measure, receive a second signaling from the network node, the second signaling including a CSI-RS port muting pattern indication indicating a modified CSI-RS measurement configuration muting at least one muted port of the first plurality of ports, and perform at least one CSI-RS measurement on at least one port of the first plurality of ports using the modified CSI-RS measurement configuration and omitting measurements on the at least one muted port.

According to one or more embodiments of this aspect, the WD is further configured to determine the modified CSI-RS measurement configuration based on the CSI-RS port muting pattern indication.

According to one or more embodiments of this aspect, the WD is further configured to receive correlation information indicating that a first plurality of CSI-RS measurements associated with the first CSI-RS measurement configuration is not correlated in time with a second plurality of CSI-RS measurements associated with the modified CSI-RS measurement configuration, the correlation information being received in one of the first signaling, the second signaling, and at least one additional signaling from the network node.

According to one or more embodiments of this aspect, the WD is further configured to receive a third signaling including a first list of CSI-RS port muting options, and the CSI-RS port muting pattern indication including an index value corresponding to one of the first list of CSI-RS port muting options.

According to one or more embodiments of this aspect, the CSI-RS port muting pattern indication includes a second list of muted ports.

According to one or more embodiments of this aspect, the WD is further configured to determine a muted port estimate, and cause transmission, to the network node, of a third signaling including an indication of the muted port estimate.

According to one or more embodiments of this aspect, the WD is further configured to receive the CSI-RS port muting pattern indication from the network node in response to the transmission of the indication of the muted port estimate.

According to one or more embodiments of this aspect, the WD is further configured to interpret the CSI-RS port muting pattern indication from the network node as an implicit indication of a confirmation of the muted port estimate.

According to one or more embodiments of this aspect, the first signaling is a radio resource control, RRC, signaling.

According to one or more embodiments of this aspect, the second signaling is one of a downlink control information, DCI, signaling and medium access control, MAC, control element, CE, signaling.

According to one or more embodiments of this aspect, the DCI signaling includes at least one of an application delay and a validity timer.

According to one or more embodiments of this aspect, the omitting includes omitting sampling of CSI-RS symbols associated with the at least one muted port.

According to one or more embodiments of this aspect, the first CSI-RS measurement configuration configures a first plurality of resource elements for measurements, and the WD being further configured to determine at least one empty resource element of the first plurality of resource elements based on the CSI-RS port muting pattern indication.

According to one or more embodiments of this aspect, the WD is further configured to receive, from the network node, a resource element indication indicating the at least one empty resource element is usable for at least one of a data reception, inter-cell interference measurements, and an inaction.

According to one or more embodiments of this aspect, the resource element indication is one of statically preconfigured by higher layer signaling, and dynamically indicated in one of a muting command and a skipping command.

According to one or more embodiments of this aspect, the resource element indication is one of associated with a single slot, and associated with a periodic pattern of slots.

According to one or more embodiments of this aspect, the WD is further configured to receive a deactivation indication, and deactivate the resource element indication responsive to receiving the deactivation indication.

According to one or more embodiments of this aspect, the WD is further configured to enter a sleep state during a first complete symbol period based on the at least one empty resource element corresponding to the first complete symbol period, and the resource element indication indicating the at least one empty resource element is usable for an inaction during the first complete symbol period.

According to one or more embodiments of this aspect, the WD is further configured to determine a data reception configuration for the at least one empty resource element based on the resource element indication indicating the at least one empty resource element is usable for data reception during the first complete symbol period.

According to one or more embodiments of this aspect, the WD is further configured to cause transmission of a fourth signaling to the network node indicating a request for a different CSI-RS muting pattern based on an uplink buffer state of the WD.

According to one or more embodiments of this aspect, the WD is further configured to reset at least one channel estimation filter for the first plurality of ports responsive to receiving the CSI-RS port muting pattern indication.

According to one or more embodiments of this aspect, the CSI-RS port muting pattern indication indicates a transmission configuration indicator (TCI) state, and the at least one muted port being associated with the TCI state.

According to one or more embodiments of this aspect, the WD is further configured to autonomously adjust at least one parameter of the first CSI-RS measurement configuration for the modified CSI-RS measurement based on a number of muted ports indicated by the CSI-RS port muting pattern indication being less than a number of ports configured for the first CSI-RS measurement configuration.

According to one or more embodiments of this aspect, autonomously adjusting the at least one parameter includes adjusting a first number of symbols configured for the first CSI-RS measurement configuration to a second number of symbols configured for the modified CSI-RS measurement configuration, the second number of symbols being less than the first number of symbols.

According to another aspect of the present disclosure, a method implemented in a wireless device, WD, configured to communicate with a network node is provided. The method includes receiving a first signaling from the network node, the first signaling including a first channel state information reference signal, CSI-RS, measurement configuration, the first CSI-RS measurement configuration indicating a first plurality of ports to measure, receiving a second signaling from the network node, the second signaling including a CSI-RS port muting pattern indication indicating a modified CSI-RS measurement configuration muting at least one muted port of the first plurality of ports, and performing at least one CSI-RS measurement on at least one port of the first plurality of ports using the modified CSI-RS measurement configuration and omitting measurements on the at least one muted port.

According to one or more embodiments of this aspect, the method further includes determining the modified CSI-RS measurement configuration based on the CSI-RS port muting pattern indication.

According to one or more embodiments of this aspect, the method further includes receiving correlation information indicating that a first plurality of CSI-RS measurements associated with the first CSI-RS measurement configuration is not correlated in time with a second plurality of CSI-RS measurements associated with the modified CSI-RS measurement configuration, the correlation information being received in one of the first signaling, the second signaling, and at least one additional signaling from the network node.

According to one or more embodiments of this aspect, method further includes receiving a third signaling including a first list of CSI-RS port muting options, and the CSI-RS port muting pattern indication including an index value corresponding to one of the first list of CSI-RS port muting options.

According to one or more embodiments of this aspect, the CSI-RS port muting pattern indication includes a second list of muted ports.

According to one or more embodiments of this aspect, the method further includes determining a muted port estimate, and transmitting, to the network node, a third signaling including an indication of the muted port estimate.

According to one or more embodiments of this aspect, the method further includes receiving the CSI-RS port muting pattern indication from the network node in response to the transmission of the indication of the muted port estimate.

According to one or more embodiments of this aspect, the method further includes interpreting the CSI-RS port muting pattern indication from the network node as an implicit indication of a confirmation of the muted port estimate.

According to one or more embodiments of this aspect, the first signaling is a radio resource control, RRC, signaling.

According to one or more embodiments of this aspect, the second signaling is one of a downlink control information, DCI, signaling and medium access control, MAC, control element, CE, signaling.

According to one or more embodiments of this aspect, the DCI signaling includes at least one of an application delay and a validity timer.

According to one or more embodiments of this aspect, the omitting includes omitting sampling of CSI-RS symbols associated with the at least one muted port.

According to one or more embodiments of this aspect, the first CSI-RS measurement configuration configures a first plurality of resource elements for measurements, and the method further including determining at least one empty resource element of the first plurality of resource elements based on the CSI-RS port muting pattern indication.

According to one or more embodiments of this aspect, the method further includes receiving, from the network node, a resource element indication indicating the at least one empty resource element is usable for at least one of a data reception, inter-cell interference measurements, and an inaction.

According to one or more embodiments of this aspect, the resource element indication is one of statically preconfigured by higher layer signaling, and dynamically indicated in one of a muting command and a skipping command.

According to one or more embodiments of this aspect, the resource element indication is one of associated with a single slot, and associated with a periodic pattern of slots.

According to one or more embodiments of this aspect, the method further includes receiving a deactivation indication, and deactivating the resource element indication responsive to receiving the deactivation indication.

According to one or more embodiments of this aspect, the method further includes entering a sleep state during a first complete symbol period based on the at least one empty resource element corresponding to the first complete symbol period, and the resource element indication indicating the at least one empty resource element is usable for an inaction during the first complete symbol period.

According to one or more embodiments of this aspect, the method further includes determining a data reception configuration for the at least one empty resource element based on the resource element indication indicating the at least one empty resource element is usable for data reception during the first complete symbol period.

According to one or more embodiments of this aspect, the method further includes transmitting a fourth signaling to the network node indicating a request for a different CSI-RS muting pattern based on an uplink buffer state of the WD.

According to one or more embodiments of this aspect, the method further includes resetting at least one channel estimation filter for the first plurality of ports responsive to receiving the CSI-RS port muting pattern indication.

According to one or more embodiments of this aspect, the CSI-RS port muting pattern indication indicates a transmission configuration indicator (TCI) state, and the at least one muted port being associated with the TCI state.

According to one or more embodiments of this aspect, the method further includes autonomously adjusting at least one parameter of the first CSI-RS measurement configuration for the modified CSI-RS measurement based on a number of muted ports indicated by the CSI-RS port muting pattern indication being less than a number of ports configured for the first CSI-RS measurement configuration.

According to one or more embodiments of this aspect, autonomously adjusting the at least one parameter includes adjusting a first number of symbols configured for the first CSI-RS measurement configuration to a second number of symbols configured for the modified CSI-RS measurement configuration, the second number of symbols being less than the first number of symbols.

According to another aspect of the present disclosure, a network node configured to communicate with a wireless device, WD is provided. The network node includes processing circuitry configured to transmit a first signaling to the WD, the first signaling including a first channel state information reference signal, CSI-RS, measurement configuration, the first CSI-RS measurement configuration indicating a first plurality of ports to measure, transmit a second signaling to the WD, the second signaling including a CSI-RS port muting pattern indication muting at least one muted port of the first plurality of ports and enabling the WD to utilize a modified CSI-RS measurement configuration for feedback reporting, and receive, from the WD, at least one CSI-RS measurement report for at least one CSI-RS measurement on at least one port of the plurality of ports using the modified CSI-RS measurement configuration and omitting measurements on the at least one muted port.

According to one or more embodiments of this aspect, the network node is further configured to determine the modified CSI-RS measurement configuration for the WD.

According to one or more embodiments of this aspect, the network node is further configured to cause transmission, to the WD, of correlation information indicating that a first plurality of CSI-RS measurements associated with the first CSI-RS measurement configuration is not correlated in time with a second plurality of CSI-RS measurements associated with the modified CSI-RS measurement configuration, the correlation information being transmitted in one of the first signaling, the second signaling, and at least one additional signaling to the WD.

According to one or more embodiments of this aspect, the network node is further configured to cause transmission of a third signaling including a first list of CSI-RS port muting options, and the CSI-RS port muting pattern indication including an index value corresponding to one of the first list of CSI-RS port muting options.

According to one or more embodiments of this aspect, the CSI-RS port muting pattern indication includes a second list of muted ports.

According to one or more embodiments of this aspect, the network node is further configured to receive, from the WD, a third signaling including an indication of the muted port estimate.

According to one or more embodiments of this aspect, the network node is further configured to cause transmission of the CSI-RS port muting pattern indication to the WD in response to the receiving of the indication of the muted port estimate.

According to one or more embodiments of this aspect, the CSI-RS port muting pattern indication corresponds to an implicit indication of a confirmation of the muted port estimate.

According to one or more embodiments of this aspect, the first signaling is a radio resource control, RRC, signaling.

According to one or more embodiments of this aspect, the second signaling is one of a downlink control information, DCI, signaling and medium access control, MAC, control element, CE, signaling.

According to one or more embodiments of this aspect, the DCI signaling includes at least one of an application delay and a validity timer.

According to one or more embodiments of this aspect, the omitting includes configuring the WD to omit sampling of CSI-RS symbols associated with the at least one muted port.

According to one or more embodiments of this aspect, the first CSI-RS measurement configuration configures a first plurality of resource elements for measurements, and the network node being further configured to determine at least one empty resource element of the first plurality of resource elements based on the CSI-RS port muting pattern indication.

According to one or more embodiments of this aspect, the network node is further configured to cause transmission, to the WD, of a resource element indication indicating the at least one empty resource element is usable for at least one of a data reception, inter-cell interference measurements, and an inaction.

According to one or more embodiments of this aspect, the resource element indication is one of statically preconfigured by higher layer signaling, and dynamically indicated in one of a muting command and a skipping command.

According to one or more embodiments of this aspect, the resource element indication is one of associated with a single slot, and associated with a periodic pattern of slots.

According to one or more embodiments of this aspect, the network node is further configured to cause transmission of a deactivation indication configuring the WD to deactivate the resource element indication responsive to receiving the deactivation indication.

According to one or more embodiments of this aspect, the transmission of the resource element indication to the WD enables the WD to enter a sleep state during a first complete symbol period based on the at least one empty resource element corresponding to the first complete symbol period, and the resource element indication indicating the at least one empty resource element is usable for an inaction during the first complete symbol period.

According to one or more embodiments of this aspect, the network node is further configured to determine a data transmission configuration for the at least one empty resource element based on the resource element indication indicating the at least one empty resource element is usable for data reception by the WD during the first complete symbol period.

According to one or more embodiments of this aspect, the network node is further configured to receive a fourth signaling from the WD indicating a request for a different CSI-RS muting pattern based on an uplink buffer state of the WD.

According to one or more embodiments of this aspect, the network node is further configured to configure the WD to reset at least one channel estimation filter for the first plurality of ports responsive to the WD receiving the CSI-RS port muting pattern indication.

According to one or more embodiments of this aspect, the CSI-RS port muting pattern indication indicates a transmission configuration indicator (TCI) state, and the at least one muted port being associated with the TCI state.

According to one or more embodiments of this aspect, the network node is further configured to determine at least one adjusted parameter of the first CSI-RS measurement configuration for the modified CSI-RS measurement based on a number of muted ports indicated by the CSI-RS port muting pattern indication being less than a number of ports configured for the first CSI-RS measurement configuration.

According to one or more embodiments of this aspect, the at least one adjusted parameter includes a first number of symbols configured for the first CSI-RS measurement configuration being adjusted to a second number of symbols configured for the modified CSI-RS measurement configuration, the second number of symbols being less than the first number of symbols.

According to another aspect of the present disclosure, a method implemented in a network node configured to communicate with a wireless device, WD, is provided. The method includes transmitting a first signaling to the WD, the first signaling including a first channel state information reference signal, CSI-RS, measurement configuration, the first CSI-RS measurement configuration indicating a first plurality of ports to measure, transmitting a second signaling to the WD, the second signaling including a CSI-RS port muting pattern indication muting at least one muted port of the first plurality of ports and enabling the WD to utilize a modified CSI-RS measurement configuration for feedback reporting, and receiving, from the WD, at least one CSI-RS measurement report for at least one CSI-RS measurement on at least one port of the plurality of ports using the modified CSI-RS measurement configuration and omitting measurements on the at least one muted port.

According to one or more embodiments of this aspect, the method further includes determining the modified CSI-RS measurement configuration for the WD.

According to one or more embodiments of this aspect, the method further includes transmitting, to the WD, correlation information indicating that a first plurality of CSI-RS measurements associated with the first CSI-RS measurement configuration is not correlated in time with a second plurality of CSI-RS measurements associated with the modified CSI-RS measurement configuration, the correlation information being transmitted in one of the first signaling, the second signaling, and at least one additional signaling to the WD.

According to one or more embodiments of this aspect, the method further includes transmitting a third signaling including a first list of CSI-RS port muting options, and the CSI-RS port muting pattern indication including an index value corresponding to one of the first list of CSI-RS port muting options.

According to one or more embodiments of this aspect, the CSI-RS port muting pattern indication includes a second list of muted ports.

According to one or more embodiments of this aspect, the method further includes receiving, from the WD, a third signaling including an indication of the muted port estimate.

According to one or more embodiments of this aspect, the method further includes transmitting of the CSI-RS port muting pattern indication to the WD in response to the receiving of the indication of the muted port estimate.

According to one or more embodiments of this aspect, the CSI-RS port muting pattern indication corresponds to an implicit indication of a confirmation of the muted port estimate.

According to one or more embodiments of this aspect, the first signaling is a radio resource control, RRC, signaling.

According to one or more embodiments of this aspect, the second signaling is one of a downlink control information, DCI, signaling and medium access control, MAC, control element, CE, signaling.

According to one or more embodiments of this aspect, the DCI signaling includes at least one of an application delay and a validity timer.

According to one or more embodiments of this aspect, the omitting includes configuring the WD to omit sampling of CSI-RS symbols associated with the at least one muted port.

According to one or more embodiments of this aspect, the first CSI-RS measurement configuration configures a first plurality of resource elements for measurements, and the method further including determining at least one empty resource element of the first plurality of resource elements based on the CSI-RS port muting pattern indication.

According to one or more embodiments of this aspect, the method further includes transmitting, to the WD, a resource element indication indicating the at least one empty resource element is usable for at least one of a data reception, inter-cell interference measurements, and an inaction.

According to one or more embodiments of this aspect, the resource element indication is one of statically preconfigured by higher layer signaling, and dynamically indicated in one of a muting command and a skipping command.

According to one or more embodiments of this aspect, the resource element indication is one of associated with a single slot, and associated with a periodic pattern of slots.

According to one or more embodiments of this aspect, the method further includes transmitting a deactivation indication configuring the WD to deactivate the resource element indication responsive to receiving the deactivation indication.

According to one or more embodiments of this aspect, the transmission of the resource element indication to the WD enables the WD to enter a sleep state during a first complete symbol period based on the at least one empty resource element corresponding to the first complete symbol period, and the resource element indication indicating the at least one empty resource element is usable for an inaction during the first complete symbol period.

According to one or more embodiments of this aspect, the method further includes determining a data transmission configuration for the at least one empty resource element based on the resource element indication indicating the at least one empty resource element is usable for data reception by the WD during the first complete symbol period.

According to one or more embodiments of this aspect, the method further includes receiving a fourth signaling from the WD indicating a request for a different CSI-RS muting pattern based on an uplink buffer state of the WD.

According to one or more embodiments of this aspect, the method further includes configuring the WD to reset at least one channel estimation filter for the first plurality of ports responsive to the WD receiving the CSI-RS port muting pattern indication.

According to one or more embodiments of this aspect, the CSI-RS port muting pattern indication indicates a transmission configuration indicator (TCI) state, and the at least one muted port being associated with the TCI state.

According to one or more embodiments of this aspect, the method further includes determining at least one adjusted parameter of the first CSI-RS measurement configuration for the modified CSI-RS measurement based on a number of muted ports indicated by the CSI-RS port muting pattern indication being less than a number of ports configured for the first CSI-RS measurement configuration.

According to one or more embodiments of this aspect, the at least one adjusted parameter includes a first number of symbols configured for the first CSI-RS measurement configuration being adjusted to a second number of symbols configured for the modified CSI-RS measurement configuration, the second number of symbols being less than the first number of symbols.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram illustrating example resource configurations such as 1, 2, and 4 symbol resources;

FIG. 2 is a schematic diagram of an example network architecture illustrating a communication system connected via an intermediate network to a host computer according to the principles in the present disclosure;

FIG. 3 is a block diagram of a host computer communicating via a network node with a wireless device over an at least partially wireless connection according to some embodiments of the present disclosure;

FIG. 4 is a flowchart illustrating example methods implemented in a communication system including a host computer, a network node and a wireless device for executing a client application at a wireless device according to some embodiments of the present disclosure;

FIG. 5 is a flowchart illustrating example methods implemented in a communication system including a host computer, a network node and a wireless device for receiving user data at a wireless device according to some embodiments of the present disclosure;

FIG. 6 is a flowchart illustrating example methods implemented in a communication system including a host computer, a network node and a wireless device for receiving user data from the wireless device at a host computer according to some embodiments of the present disclosure;

FIG. 7 is a flowchart illustrating example methods implemented in a communication system including a host computer, a network node and a wireless device for receiving user data at a host computer according to some embodiments of the present disclosure;

FIG. 8 is a flowchart of an example process in a WD according to some embodiments of the present disclosure;

FIG. 9 is a flowchart of an example process in a network node according to some embodiments of the present disclosure;

FIG. 10 is a flowchart of another example process in a WD according to some embodiments of the present disclosure;

FIG. 11 is a flowchart of another example process in a network node according to some embodiments of the present disclosure;

FIG. 12 shows an example panel muting including one or more muting patterns according to some embodiments of the present disclosure; and

FIG. 13 shows example ports mapped to antenna elements according to some embodiments of the present disclosure; and

FIG. 14 shows an example of power consumption across one or more symbols according to some embodiments of the present disclosure.

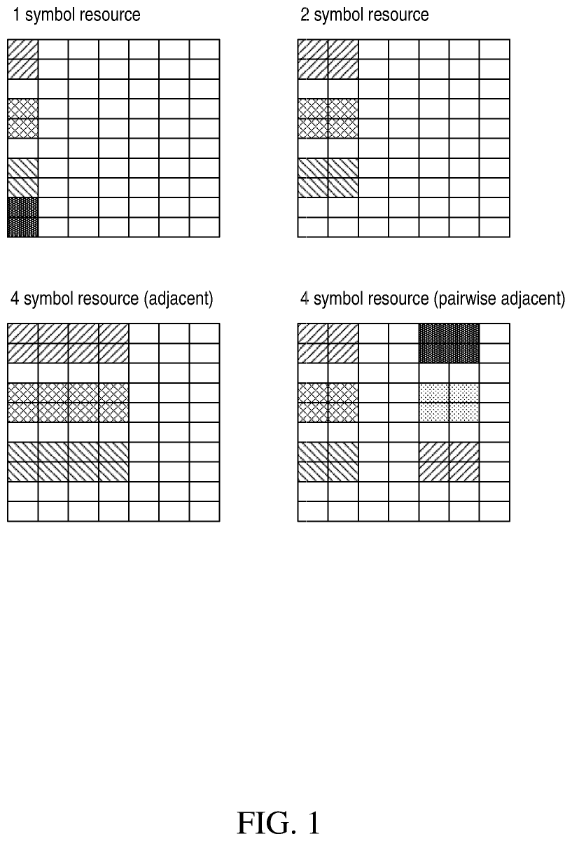

### DETAILED DESCRIPTION

Before describing in detail example embodiments, it is noted that the embodiments reside primarily in combinations of apparatus components and processing steps related to management of communication ports, e.g., port muting suing port muting indication(s) transmitted by a network node to one or more WDs. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

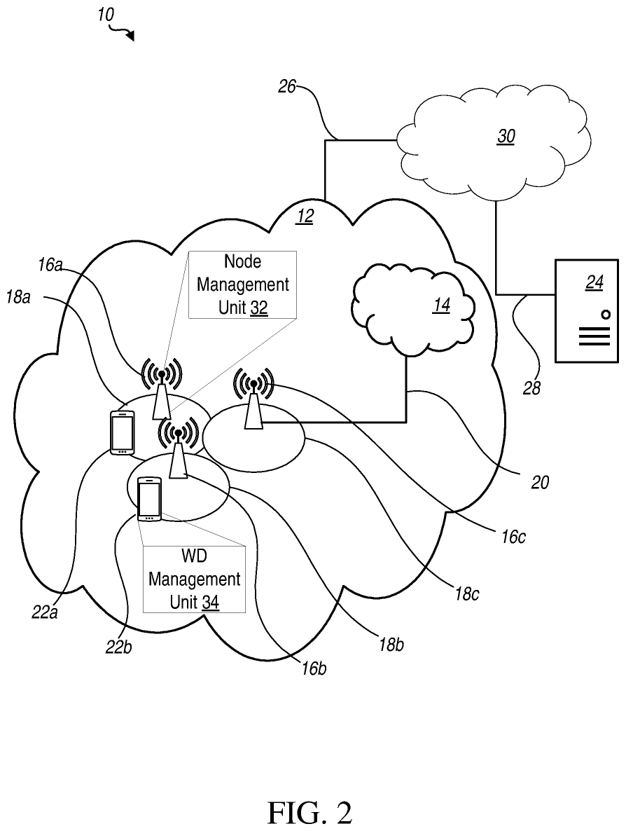

Referring again to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a node management unit 32 which is configured to perform any step and/or method and/or task and/or process and/or feature described herein, e.g., transmit (e.g., cause to transmit) a first signaling and/or a second signaling from the network node, the second signaling comprising a CSI-RS port muting pattern indication, where the second signaling triggers the WD to perform at least one CSI-RS measurement using a modified CSI-RS measurement configuration omitting a second set of ports. A wireless device 22 is configured to include a WD management unit 34 which is configured to perform any step and/or method and/or task and/or process and/or feature described herein, e.g., perform at least one CSI-RS measurement using a modified CSI-RS measurement configuration omitting a second set of ports, the at least one CSI-RS measurement being performed based on the CSI-RS port muting pattern indication

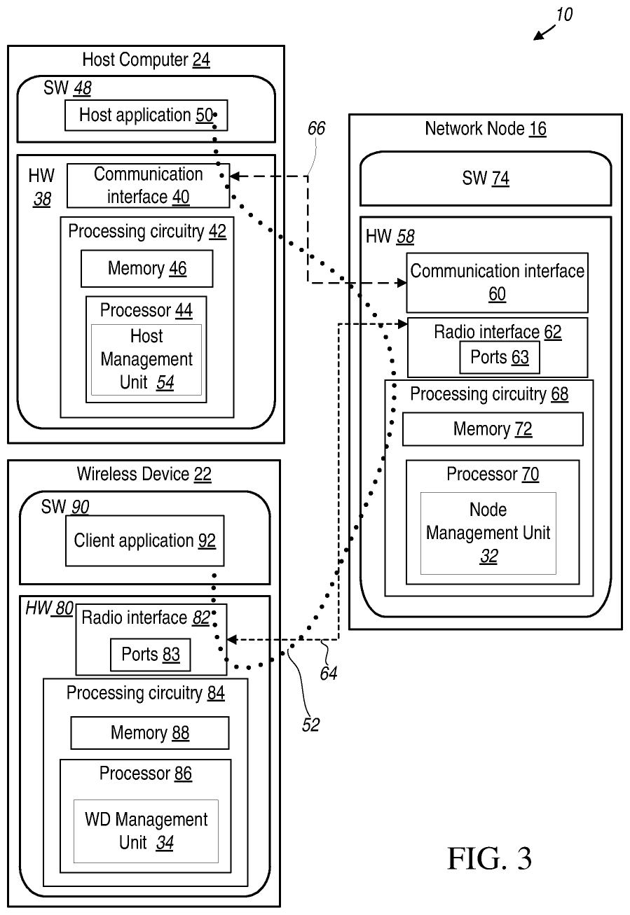

Example implementations, in accordance with an embodiment, of the WD 22, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a host management unit 54 configured to enable the service provider to perform any step and/or method and/or task and/or process and/or feature described herein, e.g., observe/monitor/control/transmit to/receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may include one or more ports 63. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a node management unit 32 which is configured to perform any step and/or method and/or task and/or process and/or feature described herein, e.g., transmit (e.g., cause to transmit) a first signaling and/or a second signaling from the network node, the second signaling comprising a CSI-RS port muting pattern indication, where the second signaling triggers the WD to perform at least one CSI-RS measurement using a modified CSI-RS measurement configuration omitting a second set of ports.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may include one or more ports 83. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD management unit 34 which is configured to perform any step and/or method and/or task and/or process and/or feature described herein, e.g., perform at least one CSI-RS measurement using a modified CSI-RS measurement configuration omitting a second set of ports, the at least one CSI-RS measurement being performed based on the CSI-RS port muting pattern indication.

In some embodiments, the inner workings of the network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as node management unit 32, and WD management unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

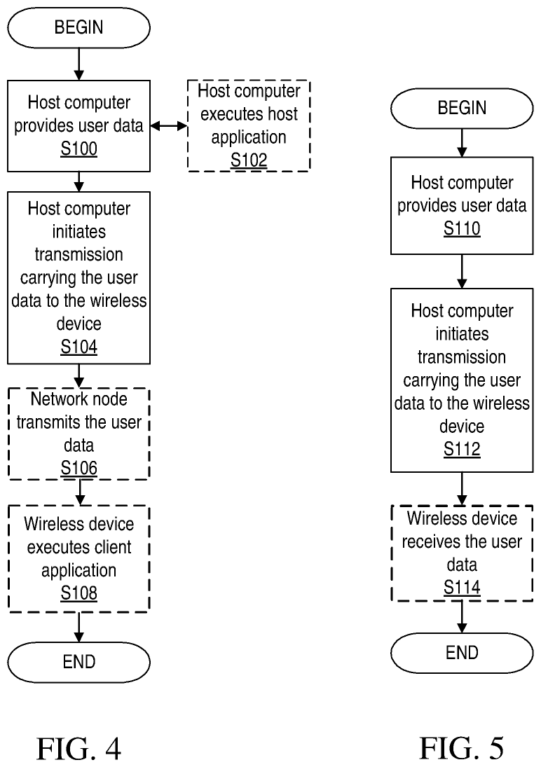

FIG. 4 is a flowchart illustrating an example method implemented in a communication system, such as, for example, the communication system of FIGS. 2 and 3, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

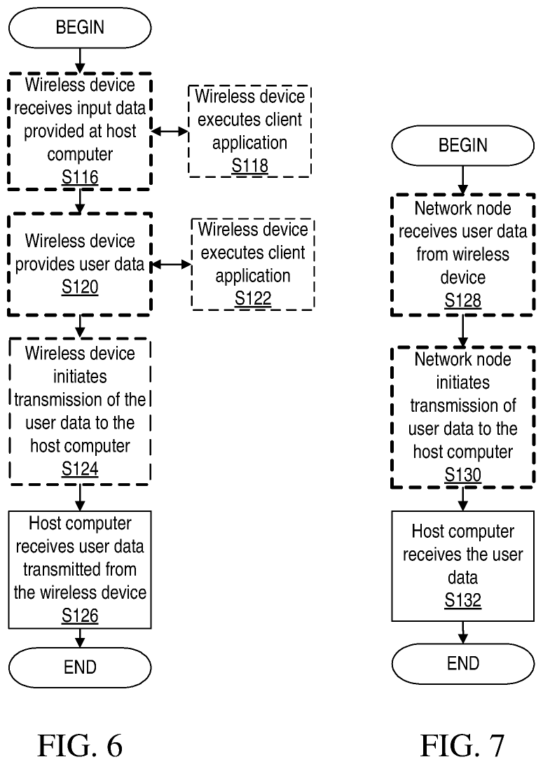

FIG. 6 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

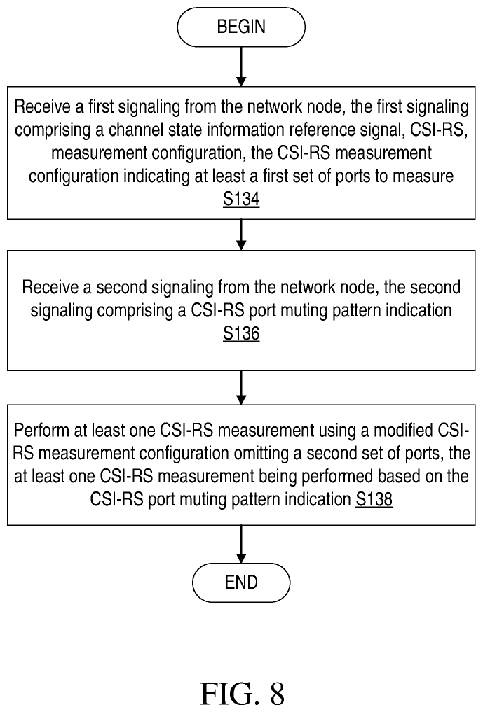

FIG. 8 is a flowchart of an example process in a WD 22 according to some embodiments of the present disclosure. One or more blocks described herein may be performed by one or more elements of wireless device 22 such as by one or more of processing circuitry 84 (including the WD management unit 34), processor 86, radio interface 82 and/or communication interface 60. Wireless device 22 such as via processing circuitry 84 and/or processor 86 and/or radio interface 82 is configured to: receive (Block S134) a first signaling from the network node, the first signaling comprising a channel state information reference signal, CSI-RS, measurement configuration, the CSI-RS measurement configuration indicating at least a first set of ports to measure; receiving (Block S136) a second signaling from the network node, the second signaling comprising a CSI-RS port muting pattern indication; and performing (Block S138) at least one CSI-RS measurement using a modified CSI-RS measurement configuration omitting a second set of ports, the at least one CSI-RS measurement being performed based on the CSI-RS port muting pattern indication.

In some embodiments, the method further includes receiving a third signaling comprising a first list of CSI-RS port muting options, where the CSI-RS port muting pattern indication includes an index into the list of CSI-RS port muting options.

In some other embodiments, the CSI-RS port muting pattern indication comprises a second list of muted ports.

In one embodiment, the method further includes transmitting a muted port estimate to the network node, where the CSI-RS port muting pattern indication is a confirmation of the muted port estimate.

In another embodiment, the first signaling is a remote radio control, RRC, signaling.

In some embodiments, the second signaling is one of a download control information, DCI, signaling and medium access control, MAC, control element, CE, signaling.

In some other embodiments, the DCI signaling includes at least one of an application delay and a validity timer.

In one embodiment, the omitting comprises omitting sampling CSI-RS symbols associated with the second set of ports.

In another embodiment, the method further includes, when a muting pattern leads to at least one empty resource element, receiving, from the network node, a resource element indication indicating the at least one empty resource element is usable for at least one purpose.

In some embodiments, the at least one purpose may be at least one of a data reception, interference measurements, an inaction.

In some other embodiments, the resource element indication is preconfigured by higher layer signaling.

In one embodiment, the resource element indication is dynamic and included in one of a muting command and a skipping command.

In another embodiment, the resource element indication is one of one-shot, configured with a pattern, and usable until one port is unmuted.

In some embodiments, the at least one purpose is specified per muted port.

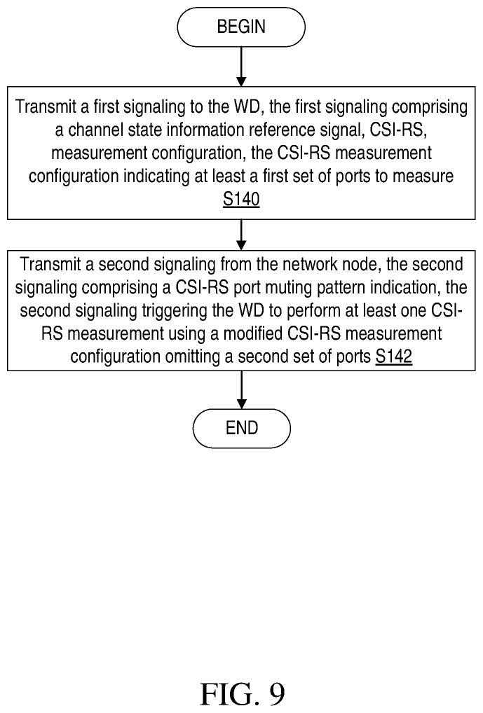

FIG. 9 is a flowchart of an example process in a network node 16 according to some embodiments of the present disclosure. One or more blocks described herein may be performed by one or more elements of network node 16 such as by one or more of processing circuitry 68 (including the node management unit 32), processor 70, radio interface 62 and/or communication interface 60. Network node 16 such as via processing circuitry 68 and/or processor 70 and/or radio interface 62 and/or communication interface 60 is configured to: transmit (Block S140) a first signaling to the WD, the first signaling comprising a channel state information reference signal, CSI-RS, measurement configuration, the CSI-RS measurement configuration indicating at least a first set of ports to measure; and transmit (Block S142) a second signaling from the network node, the second signaling comprising a CSI-RS port muting pattern indication, the second signaling triggering the WD to perform at least one CSI-RS measurement using a modified CSI-RS measurement configuration omitting a second set of ports.

In some embodiments, the method further includes transmitting a third signaling comprising a first list of CSI-RS port muting options. The CSI-RS port muting pattern indication comprises an index into the list of CSI-RS port muting options.

In some other embodiments, the CSI-RS port muting pattern indication comprises a second list of muted ports.

In one embodiment, the method further includes receiving a muted port estimate from the WD, where the CSI-RS port muting pattern indication is a confirmation of the muted port estimate.

In another embodiment, the first signaling is a remote radio control, RRC, signaling.

In some embodiments, the second signaling is one of a download control information, DCI, signaling and medium access control, MAC, control element, CE, signaling.

In some other embodiment, the DCI signaling includes at least one of an application delay and a validity timer.

In one embodiment, the omitting comprises omitting sampling CSI-RS symbols associated with the second set of ports.

In another embodiment, the method further includes, when a muting pattern leads to at least one empty resource element, transmitting, to the WD, a resource element indication indicating the at least one empty resource element is usable for at least one purpose.

In some embodiments, the at least one purpose may be at least one of a data reception, interference measurements, an inaction.

In some other embodiments, the resource element indication is preconfigured by higher layer signaling.

In one embodiment, the resource element indication is dynamic and included in one of a muting command and a skipping command.

In another embodiment, the resource element indication is one of one-shot, configured with a pattern, and usable until one port is unmuted.

In some embodiments, the at least one purpose is specified per muted port.

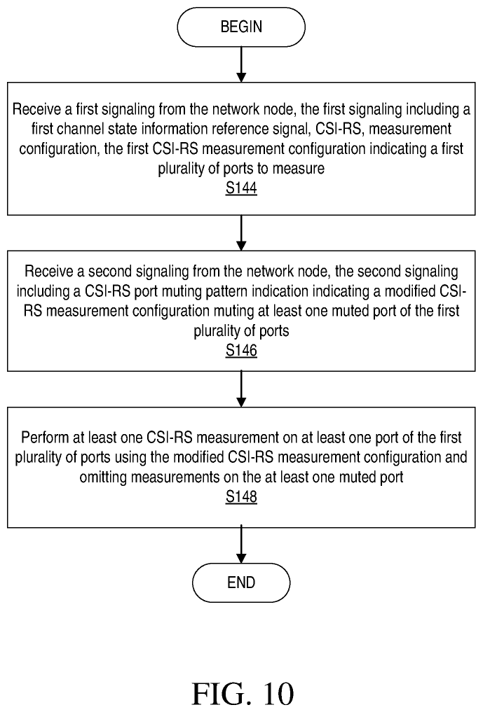

FIG. 10 is a flowchart of another example process in a WD 22 according to some embodiments of the present disclosure. One or more blocks described herein may be performed by one or more elements of wireless device 22 such as by one or more of processing circuitry 84 (including the WD management unit 34), processor 86, radio interface 82 and/or communication interface 60. Wireless device 22 is configured to receive (Block S144) a first signaling from the network node 16, the first signaling including a first channel state information reference signal, CSI-RS, measurement configuration, the first CSI-RS measurement configuration indicating a first plurality of ports to measure. Wireless device 22 is configured to receive (Block S146) a second signaling from the network node 16, the second signaling including a CSI-RS port muting pattern indication indicating a modified CSI-RS measurement configuration muting at least one muted port of the first plurality of ports. Wireless device 22 is configured to perform (Block S148) at least one CSI-RS measurement on at least one port of the first plurality of ports using the modified CSI-RS measurement configuration and omitting measurements on the at least one muted port.

In some embodiments, the method further includes determining the modified CSI-RS measurement configuration based on the CSI-RS port muting pattern indication.

In some embodiments, the method further includes receiving correlation information indicating that a first plurality of CSI-RS measurements associated with the first CSI-RS measurement configuration is not correlated in time with a second plurality of CSI-RS measurements associated with the modified CSI-RS measurement configuration, the correlation information being received in one of the first signaling, the second signaling, and at least one additional signaling from the network node 16.

In some embodiments, method further includes receiving a third signaling including a first list of CSI-RS port muting options, and the CSI-RS port muting pattern indication including an index value corresponding to one of the first list of CSI-RS port muting options.

In some embodiments, the CSI-RS port muting pattern indication includes a second list of muted ports.

In some embodiments, the method further includes determining a muted port estimate, and transmitting, to the network node 16, a third signaling including an indication of the muted port estimate.

In some embodiments, the method further includes receiving the CSI-RS port muting pattern indication from the network node 16 in response to the transmission of the indication of the muted port estimate.

In some embodiments, the method further includes interpreting the CSI-RS port muting pattern indication from the network node 16 as an implicit indication of a confirmation of the muted port estimate.

In some embodiments, the first signaling is a radio resource control, RRC, signaling.

In some embodiments, the second signaling is one of a downlink control information, DCI, signaling and medium access control, MAC, control element, CE, signaling.

In some embodiments, the DCI signaling includes at least one of an application delay and a validity timer.

In some embodiments, the omitting includes omitting sampling of CSI-RS symbols associated with the at least one muted port.

In some embodiments, the first CSI-RS measurement configuration configures a first plurality of resource elements for measurements, and the method further including determining at least one empty resource element of the first plurality of resource elements based on the CSI-RS port muting pattern indication.

In some embodiments, the method further includes receiving, from the network node 16, a resource element indication indicating the at least one empty resource element is usable for at least one of a data reception, inter-cell interference measurements, and an inaction.

In some embodiments, the resource element indication is one of statically preconfigured by higher layer signaling, and dynamically indicated in one of a muting command and a skipping command.

In some embodiments, the resource element indication is one of associated with a single slot, and associated with a periodic pattern of slots.

In some embodiments, the method further includes receiving a deactivation indication, and deactivating the resource element indication responsive to receiving the deactivation indication.

In some embodiments, the method further includes entering a sleep state during a first complete symbol period based on the at least one empty resource element corresponding to the first complete symbol period, and the resource element indication indicating the at least one empty resource element is usable for an inaction during the first complete symbol period.

In some embodiments, the method further includes determining a data reception configuration for the at least one empty resource element based on the resource element indication indicating the at least one empty resource element is usable for data reception during the first complete symbol period.

In some embodiments, the method further includes transmitting a fourth signaling to the network node 16 indicating a request for a different CSI-RS muting pattern based on an uplink buffer state of the WD 22.

In some embodiments, the method further includes resetting at least one channel estimation filter for the first plurality of ports responsive to receiving the CSI-RS port muting pattern indication.

In some embodiments, the CSI-RS port muting pattern indication indicates a transmission configuration indicator (TCI) state, and the at least one muted port being associated with the TCI state.

In some embodiments, the method further includes autonomously adjusting at least one parameter of the first CSI-RS measurement configuration for the modified CSI-RS measurement based on a number of muted ports indicated by the CSI-RS port muting pattern indication being less than a number of ports configured for the first CSI-RS measurement configuration.

In some embodiments, autonomously adjusting the at least one parameter includes adjusting a first number of symbols configured for the first CSI-RS measurement configuration to a second number of symbols configured for the modified CSI-RS measurement configuration, the second number of symbols being less than the first number of symbols.

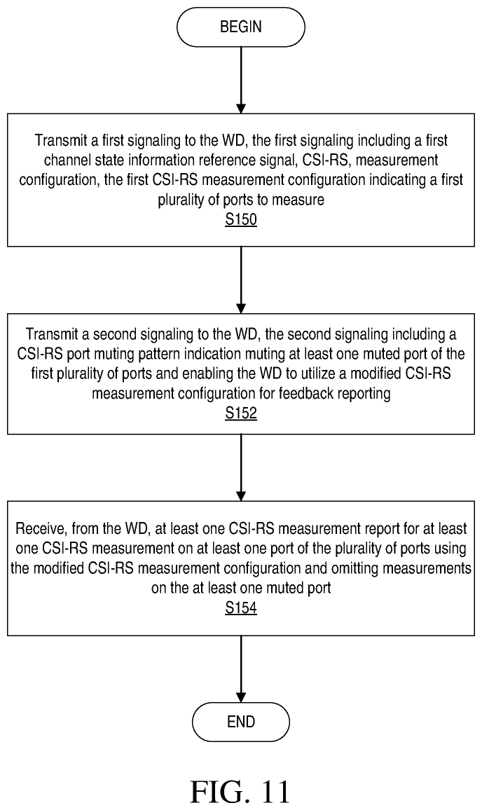

FIG. 11 is a flowchart of another example process in a network node 16 according to some embodiments of the present disclosure. One or more blocks described herein may be performed by one or more elements of network node 16 such as by one or more of processing circuitry 68 (including the node management unit 32), processor 70, radio interface 62 and/or communication interface 60. Network node 16 is configured to transmit (Block S150) a first signaling to the WD 22, the first signaling including a first channel state information reference signal, CSI-RS, measurement configuration, the first CSI-RS measurement configuration indicating a first plurality of ports to measure. Network node 16 is configured to transmit (Block S152) a second signaling to the WD 22, the second signaling including a CSI-RS port muting pattern indication muting at least one muted port of the first plurality of ports and enabling the WD 22 to utilize a modified CSI-RS measurement configuration for feedback reporting. Network node 16 is configured to receive (Block S154), from the WD 22, at least one CSI-RS measurement report for at least one CSI-RS measurement on at least one port of the plurality of ports using the modified CSI-RS measurement configuration and omitting measurements on the at least one muted port.

In some embodiments, the method further includes determining the modified CSI-RS measurement configuration for the WD 22.

In some embodiments, the method further includes transmitting, to the WD 22, correlation information indicating that a first plurality of CSI-RS measurements associated with the first CSI-RS measurement configuration is not correlated in time with a second plurality of CSI-RS measurements associated with the modified CSI-RS measurement configuration, the correlation information being transmitted in one of the first signaling, the second signaling, and at least one additional signaling to the WD 22.

In some embodiments, the method further includes transmitting a third signaling including a first list of CSI-RS port muting options, and the CSI-RS port muting pattern indication including an index value corresponding to one of the first list of CSI-RS port muting options.

In some embodiments, the CSI-RS port muting pattern indication includes a second list of muted ports.

In some embodiments, the method further includes receiving, from the WD 22, a third signaling including an indication of the muted port estimate.

In some embodiments, the method further includes transmitting of the CSI-RS port muting pattern indication to the WD 22 in response to the receiving of the indication of the muted port estimate.

In some embodiments, the CSI-RS port muting pattern indication corresponds to an implicit indication of a confirmation of the muted port estimate.

In some embodiments, the first signaling is a radio resource control, RRC, signaling.

In some embodiments, the second signaling is one of a downlink control information, DCI, signaling and medium access control, MAC, control element, CE, signaling.

In some embodiments, the DCI signaling includes at least one of an application delay and a validity timer.

In some embodiments, the omitting includes configuring the WD 22 to omit sampling of CSI-RS symbols associated with the at least one muted port.

In some embodiments, the first CSI-RS measurement configuration configures a first plurality of resource elements for measurements, and the method further including determining at least one empty resource element of the first plurality of resource elements based on the CSI-RS port muting pattern indication.

In some embodiments, the method further includes transmitting, to the WD 22, a resource element indication indicating the at least one empty resource element is usable for at least one of a data reception, inter-cell interference measurements, and an inaction.

In some embodiments, the resource element indication is one of statically preconfigured by higher layer signaling, and dynamically indicated in one of a muting command and a skipping command.

In some embodiments, the resource element indication is one of associated with a single slot, and associated with a periodic pattern of slots.

In some embodiments, the method further includes transmitting a deactivation indication configuring the WD 22 to deactivate the resource element indication responsive to receiving the deactivation indication.

In some embodiments, the transmission of the resource element indication to the WD 22 enables the WD 22 to enter a sleep state during a first complete symbol period based on the at least one empty resource element corresponding to the first complete symbol period, and the resource element indication indicating the at least one empty resource element is usable for an inaction during the first complete symbol period.

In some embodiments, the method further includes determining a data transmission configuration for the at least one empty resource element based on the resource element indication indicating the at least one empty resource element is usable for data reception by the WD 22 during the first complete symbol period.

In some embodiments, the method further includes receiving a fourth signaling from the WD 22 indicating a request for a different CSI-RS muting pattern based on an uplink buffer state of the WD 22.

In some embodiments, the method further includes configuring the WD 22 to reset at least one channel estimation filter for the first plurality of ports responsive to the WD 22 receiving the CSI-RS port muting pattern indication.

In some embodiments, the CSI-RS port muting pattern indication indicates a transmission configuration indicator (TCI) state, and the at least one muted port being associated with the TCI state.

In some embodiments, the method further includes determining at least one adjusted parameter of the first CSI-RS measurement configuration for the modified CSI-RS measurement based on a number of muted ports indicated by the CSI-RS port muting pattern indication being less than a number of ports configured for the first CSI-RS measurement configuration.

In some embodiments, the at least one adjusted parameter includes a first number of symbols configured for the first CSI-RS measurement configuration being adjusted to a second number of symbols configured for the modified CSI-RS measurement configuration, the second number of symbols being less than the first number of symbols.

Having described the general process flow of arrangements of the disclosure and having provided examples of hardware and software arrangements for implementing the processes and functions of the disclosure, the sections below provide details and examples of arrangements for management of communication ports, e.g., port muting suing port muting indication(s) transmitted by a network node 16 to one or more WD 22s.

An arrangement may include steps that allow dynamic CSI-RS configuration adaptation by configuring multiple resource mappings, or multiple configurations per parameter within a CSI-RS resource (e.g., different number of ports, power control offset, quasi colocation (QCL) information, etc.) and using MAC CE or DCI to activate/deactivate a certain configuration (or switch between those configurations). WD is configured with multiple full CSI-RS resources, where the configuration step consumes resources, proportional to the number of CSI-RS ports combination to be supported. Such flexibility is not required in the port muting case since the non-muted and partially muted configurations are highly related. This method is geared towards supporting independent CSI-RS configurations.

Another arrangement may include steps where multiple port subsets (“hypotheses”) are defined and linked to the configured CSI-RS resource. Each hypothesis determines a subset of configured CSI-RS ports-how many and which-to measure and at which rate. In this method, no actual antenna muting is applied but WD 22 may be requested to measure and report specific subsets of transmitted CSI-RS ports. Since the objective of the method is to help the network node 16 (gNB) determine a favorable port and antenna muting pattern, the presentation of the hypotheses is general and flexible, and is not meant to address handling a limited number of actual muting pattern options.

According to one aspect of the present disclosure, a method (e.g., for CSI-RS measurements) in a WD 22 is described. The method may include one or more of the following:
receiving via a first signaling a CSI-RS measurement configuration from a gNB (i.e., network node 16), comprising a first set of ports to measure;
receiving via a second signaling a CSI-RS port muting pattern indication from the gNB; and
performing CSI-RS measurements using a modified CSI-RS measurement configuration omitting a second set of ports based on the port muting pattern.

In some embodiments, the method further includes receiving via a third signaling a list of CSI-RS port muting options, and the port muting pattern indication comprises an index into the list.

In some other embodiments, the port muting pattern indication comprises a list of muted ports.

In one embodiment, the method includes transmitting a muted port estimate to the network node 16 (gNB). The port muting pattern indication is a confirmation of the muted port estimate.

In another embodiment, the first signaling is RRC. In some embodiments, the second signaling is DCI and/or MAC CE. There may be one or more different options for packing information in the DCI.

In some other embodiments, the omitting comprises omitting sampling (e.g., RF turned off) CSI-RS symbols associated with the second set of ports.

In one embodiment, the method further includes, in case the muting pattern leads to empty REs (resource elements), indicating from the NW (i.e., the network node 16) to the WD 22 whether these REs can be (e.g., may be configured to be) used for other purposes.

In another embodiment, such purposes may be one or more of data reception, interference measurements, or no action (e.g., used by WD 22 for potential sleep-in case the entire symbol is off).

In some embodiments, the indication is preconfigured by higher layer signaling e.g., RRC dedicated or broadcast signaling.

In some other embodiments, the indication is dynamic and/or included in the muting/skipping command, e.g., via an index to a set of preconfigured purposes.

In some embodiments, the transmitted/received features described above (and/or contents thereof) may be determined by any one of WD 22 and/or network node 16.

In one embodiment, one or more PDSCH resource mapping patterns corresponding to the different port muting patterns may be configured/defined. Depending on which port muting pattern is indicated, e.g., via the second signaling, the corresponding PDSCH resource mapping pattern may be assumed/determined. Muting patterns may also be configured separately.

In another embodiment, a one-to-one mapping between CSI-RS for channel measurement and CSI-IM may be provided. REs corresponding to muted CSI-RS ports may be complementary interference measurement resource, e.g., in addition to the CSI-IM corresponding to the CSI-RS. For example, the interferences measured on the CSI interference measurement (CSI-IM) and on the muted CSI-RS ports may be averaged and/or combined in some other way.

In another embodiment, for CSI-RS with muted ports, the corresponding CSI-IM is not configured by the network node 16 (i.e., interference may be measured on the REs of muted CSI-RS ports).

### General Principles

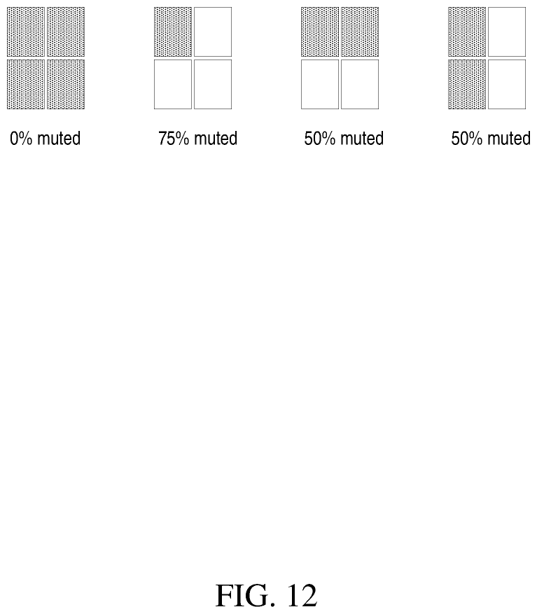

A WD power saving process for WDs 22 operating in cells (e.g., coverage areas 18) with massive multiple input multiple output (MIMO) network nodes 16 such as gNBs or other radio base station (RBS) types is described. The network node 16 may include multi-antenna arrays where parts (i.e., ports) of the array may be temporarily muted, i.e., the RF circuitry may be deactivated and/or turned off in certain parts (i.e., ports) of the array, affecting e.g., ½ of ¾ of the antenna elements. FIG. 12 shows examples of panel muting, e.g., a plurality of different muting patterns may be used, e.g., for different antenna panel sizes and geometries.

The “panel view” shown in the example of FIG. 12 is one way to reduce the number of CSI-RS ports. The power and/or the beamforming gain may be reduced, e.g., below a predetermined threshold. Since there are fewer power amplifiers left active, and each power amplifier has a fixed peak power, the total power is reduced (e.g., when compared to typical systems. The beamforming gain may also scale with the quantity of active antennas available.

In some embodiments, the quantity of active PAs is kept constant and fewer CSI-RS ports on these antennas may be used. A re-mapping of the ports-to-antenna elements may be used. Digital processing may consume more power than the PAs and by having less CSI-RS ports the network node 16 (gNB) can save energy, e.g., in the digital parts. The beamforming gain may be reduced, e.g., without having to reduce the available power. There may also be a combination of these approaches where the number of active power amplifiers are reduced, which may be less than the number of active CSI-RS ports. Depending on the implementation-specific mapping of antenna ports (and corresponding CSI-RS ports) to antenna element groups on the panel, muted elements may correspond to a subset of antenna ports for which CSI-RS measurements are configured. In muted conditions, these CSI-RS ports may not transmit any signals.

A legacy WD 22 performing CSI measurements and CSI reporting according to a full configuration may, in the presence of muting, perform sampling and processing of the CSI-RS REs associated with muted ports. WD 22 may be configured to receive signaling from the gNB (i.e., network node 16) indicating whether and which ports are muted, e.g., to avoid the associated unnecessary processing, performance degradation due noise/interference injection, and to save energy in the WD 22. Further, WD 22 may be configured to skip sampling and/or process REs corresponding to such ports to save power and increase sleep opportunities. In some embodiments, the NW (i.e., network node 16) instructs WD 22 to use potentially freed up resource elements for other purposes during the port muting/skipping period. For example, NW (i.e., network node 16) may use ZP CSI-RS configurations that can be suitably adapted to include/exclude muted CSI-RS REs according to the muting pattern.

The NW (i.e., network node 16) may achieve energy savings by employing environment knowledge obtained from WD 22 measurements in order to apply a specific antenna pattern, which may reduce the number of unnecessary CSI-RS transmissions, e.g., because of the use of less antenna elements or ports.

The principles of the present disclosure may be applied to different functional procedures, where the physical interpretation of ports may vary. In link adaptation, a port may map to a precoded or non-precoded transmission option, used by WD 22 to determine the preferred spatial precoding configuration. In beam management, ports may map to different candidate beams in the serving cell. In RRM measurements, ports may map to candidate cells or sectors for open systems interconnections (OSI) layer 3 L3 mobility management.

In the example embodiments below, the focus is on CSI-RS. However, the principles of the present disclosure are not limited as such and may be extended to the case of synchronization signal block (SSB), particularly if specific measurement procedures such as RLM, BFD, or RRM measurements are configured to be performed based on SSB measurements. In this case, WD 22 mainly saves power by avoiding measurements of SSBs which are not being transmitted due to a specific antenna muting pattern.

Furthermore, in the examples below, receiving a dynamic indication by the WD 22, i.e., MAC-CE or DCI based signaling is described. The dynamic indication may include an application delay and/or a validity timer. An application delay indicates from which starting point the indication is applicable, e.g., after a few slots, ms, subframe numbers (SFNs), etc. In one example, the application delay may be a predetermined value, e.g., from a text, where the predetermined value may depend on the numerology and/or WD 22 processing capability. In another example, the application delay may also be NW configurable. Here, the configured value may also need to be equal to or larger than a certain predetermined minimum value which depends on the numerology and/or WD 22 processing capability. A validity timer, on the other hand, may determine (i.e., refer to) how long the change indication is valid, e.g., a number of slots, frames, ms, etc. Further, the NW (i.e., network node 16) may configure WD 22 to go back to a default mode when the validity timer expires, e.g., to measure 32 ports instead of 16 at the end of validity timer. This can also be based on pre-configuration.

A high-level formulation of the principles of the present disclosure, e.g., with respect to WD 22 and/or network node 16 may be presented as follows and are described below in detail:

TABLE 2
Example port muting steps according to some
embodiments of the present disclosure.

| | |
|---|---|
| Step S1000 | Receive a CSI-RS/SSB configuration from a |
| | network node 16, e.g., gNB |
| Step S1100 | Receive a port muting pattern from the network |
| | node 16, e.g., gNB |
| Step S1150 | Receive a configuration/indication for resource |
| (optional) | element repurposing |
| Step S1200 | Perform CSI-RS/SSB measurements on a subset of |
| | configured ports |
| Step S1300 | Perform CSI-RS/SSB-related reporting |
| Step S1350 | Use the resources previously used for CSI-RS for |
| (optional) | other purposes as instructed by the NW via the |
| | network node 16 |

The example steps of Table 2 are described as follows.

### (Step S1000) CSI-RS Configuration by the NW

WD 22 receives from the serving gNB a CSI-RS measurement and/or reporting configuration (see Table 1) that may include one or more of the following aspects:
Procedure (LA, RLM, BFD, BM, RRM, etc.).
CSI-RS resources to monitor: time (OFDM symbol offset, period), frequency (SC range), code (CSI-RS scrambling sequence seed), power offset values to SSB or PDSCH, density, etc.
Time-domain behavior of CSI-RS, e.g., periodic, semi-persistent, or aperiodic.
CSI-RS port mapping to the resources.
Reporting details related to CSI-RS with muted CSI-RS ports (number of ports to be used for CSI measurement and reporting based on CSI-RS with muted CSI-RS patterns, reporting conditions/thresholds/events, time-domain behavior i.e., periodic/semi-persistent or aperiodic).

The configuration may be provided via RRC signaling. Other higher layer signaling techniques such as system information (SI) broadcast may be used particularly since a specific muting pattern can impact potentially more WDs 22 in the cell. It makes sense for WDs 22 to measure and report, e.g., (almost) at the same time. This may also be particularly relevant if a muting pattern is chosen based on SSB measurements and the system information block (SIB) can communicate the SSB related muting pattern configurations to WD 22.

### (Step S1100) Port Muting Pattern

WD 22 receives from the serving network node 16 (gNB) information about some of the ports configured in (Step S1000) being muted.

### Indicating One of Predetermined Options

In some embodiments, WD 22 first receives, e.g., in conjunction with the configuration (Step S1000), a list of possible port muting patterns. The predetermined options may also be provided to WD 22 via MAC CE signaling. The list may contain one or more options, where each option includes CSI-RS port IDs or indices that are muted, where the port IDs or indices are a subset of the ports configured in (Step S1000). The list may contain options comprising CSI-RS port IDs or indices that are not muted. Further, the list may contain an explicit list of port IDs or indices, and/or specify subgroups of ports, e.g., first/second half of the ports provided in (Step S1000).

In one embodiment, the network node 16 (gNB) is not allowed to apply (is restricted from applying) a muting pattern which leaves fewer ports being on with respect to the number of ports which are configured for a CSI-RS resource. For example, if the CSI-RS resource is configured with 16 ports, the network node 16 (gNB) may not have a muting pattern which only involves 8 ports. In another embodiment, the network node 16 (gNB) may configure a muting pattern with fewer ports than the ones configured for the CSI-RS resource, and either the other configured parameters remain the same, or one or more of them can be considered as changed automatically by WD 22 (e.g., if as the result of the change, the number of symbols would also change, etc.). For example, the CSI-RS resource may be associated with 32 ports. The muting pattern may be applicable to 16 ports, and WD 22 may assume the CSI-RS would involve 2 symbols instead of 4.

WD 22 (e.g., subsequently such as during connected mode operation) receives an indicator of the current valid muting option, e.g., index into the list of muting options. This signaling may be provided e.g., via DCI signaling, either embedded in a scheduling DCI, a separate dedicated DCI transmission, and/or a group common DCI.

In one embodiment, the muting pattern is applicable until further instructed by the NW (i.e., network node 16). In another embodiment, the muting/skipping pattern indication may further be either preconfigured or configured with a validity period. Such validity period could for example be in terms of milliseconds, slots, symbols, SFNs, or CSI-RS transmission occasions (if the ports would have been active). The range of the validity period may allow for single-shot configurations (e.g., skipping a single CSI-RS occasion).

The muting pattern can be configured as part of the regular CSI-RS configuration. When each resource is configured, an additional parameter may be provided indicating if the CSI-RS resource is part of a muting pattern or not. The parameter may indicate to which muting pattern group it belongs. For example, WD 22 may receive configuration of four CSI-RS resources, two of which configured with 16 ports, and the other two with 8 ports. The resources with 8 ports may always be active (e.g., which may be also subset of the 16 port ones). The configuration may also indicate that the first 16 port CSI-RS resource belongs to muting pattern 1 and the second one to muting pattern 2.

In some embodiments, muting patterns may be indicated with a granularity of OFDM symbols. For example, if a configured CSI-RS resource spans 4 OFDM symbols, then 4 bits may be used to indicate the one or more muting patterns, where each bit indicates whether or not the CSI-RS ports in one corresponding OFDM symbol are muted. Using one bit per OFDM symbol may be suitable when the cdm-Type of the CSI-RS is ‘fd-CDM2’ (i.e., a pair of CSI-RS ports in the CSI-RS resource are code division multiplexed via a length-2 cover code in the frequency domain over two adjacent subcarriers). For example, a cdm-Type is defined in Table 7.4.1.5.3-1 of 3GPP TS 38.214.

In another embodiment, muting patterns may be indicated with a granularity of two adjacent OFDM symbols. For instance, if a configured CSI-RS resource spans 4 OFDM symbols, then 2 bits may be used to indicate the one or more muting patterns where each bit indicates whether the CSI-RS ports in two adjacent OFDM symbols are muted (e.g., the first bit corresponds to the first two OFDM symbols of the CSI-RS resource, and the second bit corresponds to the last two OFDM symbols). Using one bit per pair of adjacent OFDM symbols may be suitable when the cdm-Type of the CSI-RS is ‘td-CDM2’ (i.e., a pair of CSI-RS ports in the CSI-RS resource are code division multiplexed via a length-2 cover code in the time domain over two adjacent OFDM symbols) or when the cdm-Type of the CSI-RS is ‘cdm4-FD2-TD2’ (i.e., a 2×2 quadruplet of CSI-RS ports in the CSI-RS resource are code division multiplexed over 2 adjacent Res in the frequency domain and 2 adjacent OFDM symbols in the time domain via a length-4 CDM code).

In yet another embodiment, muting patterns may be indicated with a granularity of CDM group. A CDM group for CSI-RS may be the CDM group defined in 3GPP TS 38.211. For a CSI-RS resource, the number of CDM groups depend on the cdm-Type configured for the CSI-RS resource. For example, a 32 port CSI-RS resource with cdm-Type set to either ‘fd-CDM2’ or ‘td-CDM2’ will have 16 CDM groups. If the 32 port CSI-RS resource is configured with cdm-Type set to ‘cdm4-FD2-TD2’, the CSI-RS resource may have 8 CDM groups. If the 32 port CSI-RS resource is configured with cdm-Type set to ‘cdm8-FD2-TD4’ (i.e., a 2×4 Octuplet of CSI-RS ports in the CSI-RS resource are code division multiplexed over 2 adjacent Res in the frequency domain and 4 adjacent OFDM symbols in the time domain via a length-8 CDM code), the CSI-RS resource may have 4 CDM groups. Then, to indicate a muting pattern N bits can be used where N is the number of CDM groups in the CSI-RS resource as defined by the configured cdm-Type. The N bits may be sequentially mapped to the CSI-RS ports in the CDM groups according to the CDM group index (e.g., as defined in 3GPP TS 38.211). The least significant bit may be mapped to the lowest CDM group index, the second least significant bit may be mapped to the second lowest CDM group index. The most significant bit may be mapped to the highest CDM group index. Similar mapping may be performed for other CDM group indices and bits combinations.

### Indicating an Explicit Subset of Ports

In some embodiments, WD 22 does not receive a preliminary list of muting options but, during connected mode operation, receives an explicit description of the current muting pattern, e.g., one or more port IDs and/or indices that are muted and/or are not muted and/or a subset indication (e.g., first/second half of the ports provided in Step S1000). This signaling may be provided e.g., via DCI, MAC CE, or a combination of MAC CE and DCI signaling. For example., a bitfield in the DCI can indicate which ports are muted. The bitfield can be configured within existing DCIs and/or one or more new DCI formats potentially scrambled with different radio network temporary identifiers (RNTIs).

### Indicating Validity of a WD Estimate

In some other embodiments, the muting pattern indication may be in the form of a confirmation from the gNB (i.e., network node 16) in response to a port muting estimation provided by WD 22.

WD 22 may estimate (i.e., determine) which ports are muted e.g., by observing signal power levels of the configured ports and detect (i.e., determine) one or more of the following: ports with power levels below a threshold; abrupt changes of signal power on some ports; reporting configurations inconsistent with CSI-RS resource configurations; and the number or pattern of ports with power below a threshold, etc.

WD 22 may (e.g., on an infrequent basis) inform the estimated port muting pattern to the network node 16 (gNB), e.g., one or more port IDs and/or indices that are muted or are not muted and/or or a subset indication (e.g., first/second half of the configured ports). In one embodiment, the signaling may use the UE assistance information (UAI) framework.

WD 22 can receive feedback from the network node 16 (gNB) confirming whether WD hypothesis is correct. The feedback may be received via e.g., RRC, MAC CE, or DCI mechanisms. In one embodiment, in the feedback, the NW (e.g., network node 16) may aid WD 22 and inform for how long the assumed hypothesis will continue to be applicable. This can be in terms of a validity duration as exemplified above.

### (Step S1150) Receive a Configuration/Indication for Resource Element Repurposing

As described above, CSI-RS patterns may accommodate multiple REs in time-and frequency domain. Depending on the density (number of REs in frequency during a certain time) of CSI-RS resources, and the NW frequency multiplexing scheme, complete OFDM symbols may be freed up during certain muting occasions. Hence, as a result of CSI-RS port muting the REs are freed up and could potentially be used for other purposes. In some embodiments, WD 22 further receives configuration and/or indication for whether the potentially freed up resources (REs) as a result of CSI-port muting may/shall be used for other purposes while muting is applicable. The REs may, for example, be repurposed for data transmission by the NW (i.e., network node 16), be used for inter-cell interference measurements by WD 22, or “no action” in which case it is left for WD implementation (i.e., for the WD 22 to determine) to whether go to a sleep state in case the complete symbol is freed up.

The repurposing configuration may be similar to (Step S1100), e.g., be preconfigured and/or dynamically indicated, and/or potentially per CSI-RS muted port/pattern, and/or either one-shot or according to a (semi-) periodical scheme including a potential validity timer. In one embodiment, the repurposing scheme may be different from the muting/skipping pattern.

In another embodiment, multiple PDSCH resource mapping patterns may be configured wherein each PDSCH resource mapping pattern may be associated with different CSI-RS muting patterns. Depending on which port muting pattern is indicated by network node 16 (e.g., the gNB) to WD 22, the corresponding PDSCH resource mapping pattern may be assumed. This allows the REs of muted CSI-RS ports to be reused for physical downlink shared channel (PDSCH) reception.

In NR, there is one-to-one mapping between CSI-RS resources used for channel measurements and CSI-IM resources used for interference measurement. In another embodiment, the REs corresponding to muted CSI-RS ports of a CSI-RS resource may complement the CSI-IM resource associated with the CSI-RS resource. That is, WD 22 may be configured to measure interference on both the CSI-IM and the REs corresponding to muted CSI-RS ports of the CSI-RS. For instance, the interferences measured on the CSI-IM and on the muted CSI-RS ports may be averaged and/or combined in some other way.

In some embodiments, for CSI-RS resources with muted ports, the corresponding CSI-IM is not configured by the network (i.e., interference is only measured on the REs of muted CSI-RS ports of the CSI-RS resource).

### (Step S1200) Omitting Measurements on Muted Ports

WD 22 may be configured to perform measurements on ports not determined as muted and/or omit measurements on ports presumed muted.

In one embodiment, WD 22 may be configured to identify (i.e., determine) if any of the configured CSI-RS symbols contain (i.e., include) muted ports (e.g., only muted ports) without any repurposing configuration. If such symbols are identified, the symbol may not be sampled, e.g., the RF stage is powered down or put in a lower-power state compared to symbols with non-muted ports that are sampled. The omitted RF activity may be utilized to extend a lower-power sleep state (e.g., light/deep sleep) to include the non-sampled symbol and possible additional symbols, e.g., symbols between the CSI-RS symbols.

In one or more embodiments, if entire symbols cannot be omitted since every CSI-RS symbol contains some non-muted ports, sampled contents of REs corresponding to muted ports may not be processed to estimate respective channel qualities. The estimation-related operations in baseband may be skipped.

In some embodiments, quality estimates for the non-sampled or non-processed ports may be set to zero or to a minimum non-zero value.

### (Step S1300) Reporting of Omitted Measurements

WD 22 may be configured to report CSI-RS measurements according to the configuration (Step S1000) received from network node 16 (e.g., the gNB). In some configurations, WD 22 may need (i.e., be configured) to indicate a measurement result for one or more ports that were indicated as muted and for which measurements were omitted. In one embodiment, WD 22 may be configured to report a zero value and/or a minimum permissible non-zero value for such ports.

Note that this can also be used to obtain additional interference estimates from WD 22. For example, if network node 16 needs (i.e., requests) updated interference estimates from a WD 22, it can mute some CSI-RS ports and still ask for measurement reports on the muted ports. These muted CSI-RS ports may not contain any reference signal and hence the report may contain an estimate (e.g., only an estimate) of the interference WD 22 receives on these ports.

Changes to reporting may not be necessary if the reporting configuration includes the best port (i.e., only the best port) and/or a number of best ports that does not exceed the number of remaining non-muted ports. In some embodiments, determining the best port for such reporting may performed by assigning a zero value to the non-measured ports.

The reporting can be configured to be periodic/semi-persistent and/or aperiodic. In another example, if the muting pattern and the measurements from the WD 22 remain the same, then WD 22 may not need to report even if configured, e.g., as in periodic and/or semi-persistent reporting. In another example, WD 22 may be configured to (e.g., is only obliged to) provide report on one or more of the muting pattern measurements occasions (e.g., and not all). The pattern for such a report can be configured by the NW (i.e., network node 16), e.g., the first instance, or pre-configured in the standards, e.g., every other instance, etc.

### (Step S1350) Use the Resources Previously Used for CSI-RS for Other Purposes as Instructed by the NW

WD 22 may be configured to treat the REs otherwise used for muted CSI-RS resources according to the instructions provided by the NW (network node 16) per (Step S1150). In case no special purpose is provided, WD 22 behaves (per Step S1200). In case the NW (i.e., network node 16) had indicated that the REs are to be used for PDSCH transmission, WD 22 treats these REs accordingly. In case, these REs are to be used for inter-cell interference estimation.

The muting pattern for CSI-RS transmissions is not limited to the antenna port domain. It is also possible to define a CSI-RS muting pattern in the time domain (e.g., every second CSI-RS transmission is muted). This enables adopting the CSI-RS periodicity to the channel Doppler frequency (related to the WD 22 mobility speed) and it enables reducing the CSI-RS overhead in some situations. It also enables additional network energy savings whenever a low mobility WD 22 is idle. Similar adaptation of the CSI-RS muting pattern can also be done in the frequency domain (e.g., the CSI-RS bandwidth is temporarily reduced).

In some embodiments, WD 22 may request a different CSI-RS muting pattern that what is currently configured. For example, in case WD 22 has knowledge (i.e., determines) that the NW (e.g., network node 16) does not have the same immediate access to (e.g., the quality for the active services, current the uplink buffer state, etc.), WD 22 can speed up the CSI-RS adaptation process by requesting a different muting pattern to be used by the network.

In some other embodiments, additional WD 22 behavior may be defined that specifies what WD 22 does when receiving a new CSI-RS muting pattern. For example, WD 22 may be instructed to upon receiving a new CSI-RS muting pattern, to reset (clear) channel estimation filters, etc.

The muting configuration/indication may, instead of being configured individually per CSI-RS ports, be configured on a group level. For example, a muting pattern may be provided for all CSI-RSs that are QCL with a certain SSB. For example, the NW (e.g., network node 16) may indicate the transmission configuration indicator (TCI) state number for which the muting is applicable, meaning that all CSI-RSs associated with that state are to be muted.

In some embodiments, the potential CSI-RS muting patterns are signaled via the cell system information. This has the advantage that is easy to achieve (e.g., by defining a system information extension in the standard) and it may be a low additional cost to add a few additional bits in an already existing system information block. In other embodiments, the potential CSI-RS muting patterns are configured using RRC and/or MAC signaling. The activation of a preconfigured CSI-RS muting pattern may be achieved through DCI signaling (on the PDCCH/ePDCCH), MAC signaling, RRC signaling, etc. A DCI message including, e.g., an index to a pre-configured CSI-RS muting pattern, may be transmitted using a dedicated RNTI (targeting a single WD 22) and/or a group RNTI (targeting several WDs 22).

In some other embodiments, various muting patterns may be configured as part of broadcast system information. These muting patterns may be predetermined, e.g., not specifically tied to a certain CSI-RS resource, but only include a specific time/frequency domain pattern. For example, a bitmap may be provided where each bit would indicate a muted frame, slot, and/or symbol depending on desired granularity and intended muting length. Similarly, a bitmap may be used for frequency domain muting pattern, where each bit would indicate a specific subcarrier, PRB, or multiples thereof. The NW (e.g., network node 16) may indicate to WDs 22 in a DCI/MAC-CE which of the patterns that are used for muting.

The DCI may be WD 22 specific, group-common, cell specific or even area specific. Among the options, group-common, cell or area specific are preferred as an antenna unit typically serves multiple WDs 22 within a cell or area. The NW may use the same DCI addressing multiple WDs 22, thereby reducing the overhead. The DCI can be any of the existing DCIs or new DCI formats, e.g., designed based on the group-common DCI format 2-6. An indication field within the DCI can indicate the applicable muting pattern e.g., for the WD 22 to report, or further indication if the muting pattern is applied. Additional information can also be provided, e.g., repurposed ports, or which ports are exactly muted, etc. In case WD 22 is in RRC_Idle/Inactive, existing DCIs (e.g., DCI 1-0 scrambled with SI-RNTI or P-RNTI or a paging early indicator DCI) can be used in order to indicate to WD 22 a specific antenna muting pattern is applied, and, e.g., if specific beams are not there anymore, without needing to go through a cumbersome SI update procedure.

The DCI can be further associated with a WD-specific or common search space, with the common search space to be the preferred option. The DCI can be scrambled with a WD-specific, or a group common RNTI, or a cell or area specific RNTI.

The indication bitfield can be configured explicitly using higher layer signaling, e.g., SIB or RRC signaling, or based on a pre-configuration e.g., as defined in a standardization documentation.

The method of indication e.g., DCI or MAC CE based, can also be configured by the network node 16 (e.g., gNB) or pre-configured. The same can be applied for the employed DCI format, RNTI, the DCI size, bitfield, bitmapping or codepoint, etc.

Although the methods above have been described with respect to one cell (and/or carrier), the principles of the present disclosure are not limited as such. In an additional further embodiment, the methods may also be applied for multiple carriers. More specifically, the indication may be applied to a group of cells (e.g., coverage areas 18). For example, each serving cell may be configured with a cell-group index. If WD 22 receives the port muting indication in one of the serving cell, the port muting (aside from the respective serving cell) may also be applied in one or more cells (e.g., all serving cells) configured with the same cell-group index. In another example, an indication received in one cell may also explicitly indicate which muting pattern should be adopted by each serving cell.

### Antenna-to-Port Mapping by NW

The NW (i.e., network node 16) may select the port-to-element mapping, e.g., so that when part of the antenna panel is muted, the muted elements will correspond to ports mapped to one CSI-RS symbol or symbol pair. This way, the symbol does not include any non-muted ports. This allows WD 22 to efficiently apply methods described herein but may also benefit NW energy efficiency, e.g., because RF/PA micro-sleep may be applied during these symbols.

Information about how the port mapping is changed may be part of the CSI-muting configuration. Sometimes an antenna panel is turned off and then the CSI-RS ports on that panel disappear. Sometimes the port mapping is changed when the CSI-RS muting pattern changes. Knowledge related to changes in port mapping could then trigger WD 22 to reset the channel estimation filtering and/or transmit an additional (a-periodic) CSI report.

### Nonlimiting Example

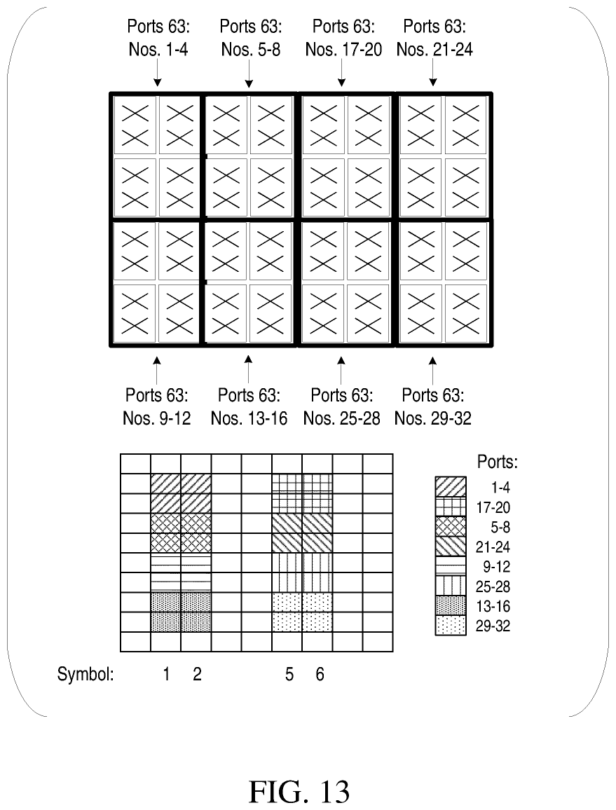

FIG. 13 is a diagram which illustrates a nonlimiting example of one or more CSI-RS ports mapped to antenna elements in the panel and/or to corresponding Res in CSI-Rs transmissions.

A portion of the panel (e.g., the right half of the panel) implementing ports 17-32, may be muted. If so, the CSI-RS Res in symbols 5 and 6 may be configured to not transmit, e.g., not transmit any energy.

Energy consumption in the network nodes 16 directly translates to heat that needs to be handled. To avoid overheating of network node 16 (e.g., the NW radio) several muting patterns may be defined with the same number of CSI-RS port(s) active. For example, assume there are 32 CSI-RS ports and that there is a fixed port-to-antenna mapping. Then a network may define:
Pattern 1: CSI-ports 1-16 are muted.
Pattern 2: CSI ports 17-32 are muted.

In both Pattern 1 and 2, there are 16 active CSI-ports. But the NW (network node 16) can switch from antenna sub-panel 1 to antenna sub-panel 2 and at the same time switch from CSI-RS port muting pattern 1 to pattern 2 if the currently active antenna subpanel is overheated.

In some other embodiments, the active CSI-RS ports may not be changed when network node 16 (e.g., the gNB) switches antenna sub-panel. An indicator may be sent to WD 22 indicating that the CSI-RS are not correlated in time before and after the switch. Further, the information related correlation of measurements before and after a muting pattern switch may be included in the CSI-RS muting configuration directly.

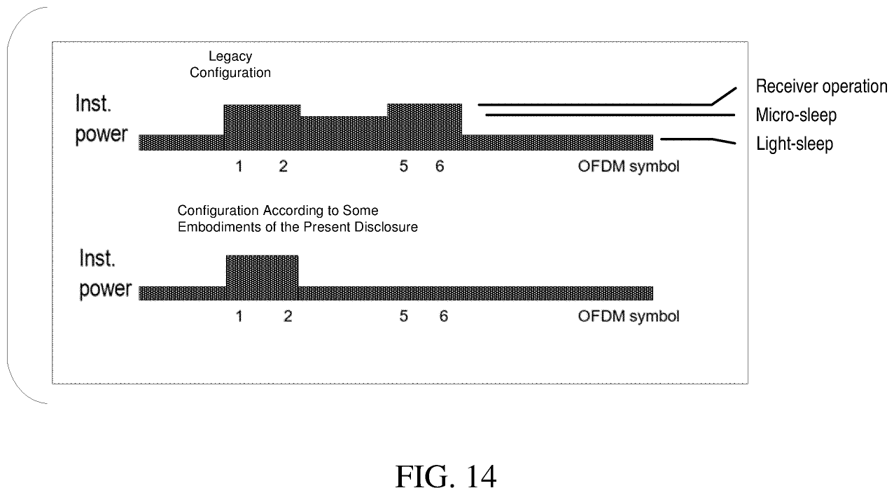

The WD 22, if the REs are not to be used for other purposes by the NW (i.e., network node 16), may omit receiving and/or processing additional symbols after, e.g., symbols 1 and 2, including the micro-sleep between the CSI-RS symbol pairs, and immediately return to light sleep. FIG. 14 shows an example of power consumption across one or more symbols according to some embodiments of the present disclosure. Power savings of WD 22 (and/or network node 16) is illustrated. More specifically, WD 22 may be configured such that instant power is reduced (or not consumed) after processing (e.g., transmitting, receiving, determining, etc.) of symbols 1 and 2.

### SOME EXAMPLES

Example A1. A wireless device, WD 22, configured to communicate with a network node 16, the WD 22 configured to, and/or comprising a radio interface 82 and/or processing circuitry 84 configured to:
receive a first signaling from the network node 16, the first signaling comprising a channel state information reference signal, CSI-RS, measurement configuration, the CSI-RS measurement configuration indicating at least a first set of ports to measure;
receive a second signaling from the network node 16, the second signaling comprising a CSI-RS port muting pattern indication; and
perform at least one CSI-RS measurement using a modified CSI-RS measurement configuration omitting a second set of ports, the at least one CSI-RS measurement being performed based on the CSI-RS port muting pattern indication.

Example A2. The WD 22 of Example A1, wherein the radio interface 82 is further configured to:
receive a third signaling comprising a first list of CSI-RS port muting options, the CSI-RS port muting pattern indication comprising an index into the list of CSI-RS port muting options.

Example A3. The WD 22 of any one of Examples A1 and A2, wherein the CSI-RS port muting pattern indication comprises a second list of muted ports.

Example A4. The WD 22 of any one of Examples A1-A3, wherein the radio interface 82 is further configured to:
transmit a muted port estimate to the network node 16, the CSI-RS port muting pattern indication being a confirmation of the muted port estimate.

Example A5. The WD 22 of any one of Examples A1-A4, wherein the first signaling is a remote radio control, RRC, signaling.

Example A6. The WD 22 of any one of Examples A1-A5, wherein the second signaling is one of a download control information, DCI, signaling and medium access control, MAC, control element, CE, signaling.

Example A7. The WD 22 of Example A6, wherein the DCI signaling includes at least one of an application delay and a validity timer.

Example A8. The WD 22 of any one of Examples A1-A7, wherein the omitting comprises omitting sampling CSI-RS symbols associated with the second set of ports.

Example A9. The WD 22 of any one of Examples A1-A8, wherein the radio interface 82 is further configured to:
when a muting pattern leads to at least one empty resource element, receive, from the network node 16, a resource element indication indicating the at least one empty resource element is usable for at least one purpose.

Example A10. The WD 22 of Example A9, wherein the at least one purpose may be at least one of a data reception, interference measurements, an inaction.

Example A11. The WD 22 of any one of Examples A9 and A10, wherein the resource element indication is preconfigured by higher layer signaling.

Example A12. The WD 22 of any one of Examples A9-A11, wherein the resource element indication is dynamic and included in one of a muting command and a skipping command.

Example A13. The WD 22 of any Example A12, wherein the resource element indication is one of one-shot, configured with a pattern, and usable until one port is unmuted.

Example A14. The WD 22 of any one of Examples A9-A13, wherein the at least one purpose is specified per muted port.

Example B1. A method in a wireless device, WD 22, configured to communicate with a network node 16, the method including:
receiving a first signaling from the network node 16, the first signaling comprising a channel state information reference signal, CSI-RS, measurement configuration, the CSI-RS measurement configuration indicating at least a first set of ports to measure;
receiving a second signaling from the network node 16, the second signaling comprising a CSI-RS port muting pattern indication; and
performing at least one CSI-RS measurement using a modified CSI-RS measurement configuration omitting a second set of ports, the at least one CSI-RS measurement being performed based on the CSI-RS port muting pattern indication.

Example B2. The method of Example B1, wherein the method further includes:
receiving a third signaling comprising a first list of CSI-RS port muting options, the CSI-RS port muting pattern indication comprising an index into the list of CSI-RS port muting options.

Example B3. The method of any one of Examples B1 and B2, wherein the CSI-RS port muting pattern indication comprises a second list of muted ports.

Example B4. The method of any one of Examples B1-B3, wherein the method further includes:
transmitting a muted port estimate to the network node 16, the CSI-RS port muting pattern indication being a confirmation of the muted port estimate.

Example B5. The method of any one of Examples B1-B4, wherein the first signaling is a remote radio control, RRC, signaling.

Example B6. The method of any one of Examples B1-B5, wherein the second signaling is one of a download control information, DCI, signaling and medium access control, MAC, control element, CE, signaling.

Example B7. The method of Example B6, wherein the DCI signaling includes at least one of an application delay and a validity timer.

Example B8. The method of any one of Examples B1-B7, wherein the omitting comprises omitting sampling CSI-RS symbols associated with the second set of ports.

Example B9. The method of any one of Examples B1-B8, wherein the method further includes:
when a muting pattern leads to at least one empty resource element, receiving, from the network node 16, a resource element indication indicating the at least one empty resource element is usable for at least one purpose.

Example B10. The method of Example B9, wherein the at least one purpose may be at least one of a data reception, interference measurements, an inaction.

Example B11. The method of any one of Examples B9 and B10, wherein the resource element indication is preconfigured by higher layer signaling.

Example B12. The method of any one of Examples B9-B11, wherein the resource element indication is dynamic and included in one of a muting command and a skipping command.

Example B13. The method of any Examples B12, wherein the resource element indication is one of one-shot, configured with a pattern, and usable until one port is unmuted.

Example B14. The method of any one of Examples B9-B13, wherein the at least one purpose is specified per muted port.

Example C1. A network node 16 configured to communicate with a wireless device, WD 22, the network node 16 configured to, and/or comprising a radio interface 62 and/or comprising processing circuitry 68 configured to:
transmit a first signaling to the WD 22, the first signaling comprising a channel state information reference signal, CSI-RS, measurement configuration, the CSI-RS measurement configuration indicating at least a first set of ports to measure; and
transmit a second signaling from the network node 16, the second signaling comprising a CSI-RS port muting pattern indication, the second signaling triggering the WD 22 to perform at least one CSI-RS measurement using a modified CSI-RS measurement configuration omitting a second set of ports.

Example C2. The network node 16 of Example C1, wherein the radio interface 62 is further configured to:
transmit a third signaling comprising a first list of CSI-RS port muting options, the CSI-RS port muting pattern indication comprising an index into the list of CSI-RS port muting options.

Example C3. The network node 16 of any one of Examples C1 and C2, wherein the CSI-RS port muting pattern indication comprises a second list of muted ports.

Example C4. The network node 16 of any one of Examples C1-C3, wherein the radio interface 62 is further configured to:
receive a muted port estimate from the WD 22, the CSI-RS port muting pattern indication being a confirmation of the muted port estimate.

Example C5. The network node 16 of any one of Examples C1-C4, wherein the first signaling is a remote radio control, RRC, signaling.

Example C6. The network node 16 of any one of Examples C1-C5, wherein the second signaling is one of a download control information, DCI, signaling and medium access control, MAC, control element, CE, signaling.

Example C7. The network node 16 of Example C6, wherein the DCI signaling includes at least one of an application delay and a validity timer.

Example C8. The network node 16 of any one of Examples C1-C7, wherein the omitting comprises omitting sampling CSI-RS symbols associated with the second set of ports.

Example C9. The network node 16 of any one of Examples C1-C8, wherein the radio interface 62 is further configured to:
when a muting pattern leads to at least one empty resource element, transmit, to the WD 22, a resource element indication indicating the at least one empty resource element is usable for at least one purpose.

Example C10. The network node 16 of Example C9, wherein the at least one purpose may be at least one of a data reception, interference measurements, an inaction.

Example C11. The network node 16 of any one of Examples C9 and C10, wherein the resource element indication is preconfigured by higher layer signaling.

Example C12. The network node 16 of any one of Examples C9-C11, wherein the resource element indication is dynamic and included in one of a muting command and a skipping command.

Example C13. The network node 16 of any Example C12, wherein the resource element indication is one of one-shot, configured with a pattern, and usable until one port is unmuted.

Example C14. The network node 16 of any one of Examples C9-C13, wherein the at least one purpose is specified per muted port.

Example D1. A method in a network node 16 configured to communicate with a wireless device, WD 22, the method comprising:
transmitting a first signaling to the WD 22, the first signaling comprising a channel state information reference signal, CSI-RS, measurement configuration, the CSI-RS measurement configuration indicating at least a first set of ports to measure; and
transmitting a second signaling from the network node 16, the second signaling comprising a CSI-RS port muting pattern indication, the second signaling triggering the WD 22 to perform at least one CSI-RS measurement using a modified CSI-RS measurement configuration omitting a second set of ports.

Example D2. The method of Example D1, wherein the method further includes:
transmitting a third signaling comprising a first list of CSI-RS port muting options, the CSI-RS port muting pattern indication comprising an index into the list of CSI-RS port muting options.

Example D3. The method of any one of Examples D1 and D2, wherein the CSI-RS port muting pattern indication comprises a second list of muted ports.

Example D4. The method of any one of Examples D1-D3, wherein the method further includes:
receiving a muted port estimate from the WD 22, the CSI-RS port muting pattern indication being a confirmation of the muted port estimate.

Example D5. The method of any one of Examples D1-D4, wherein the first signaling is a remote radio control, RRC, signaling.

Example D6. The method of any one of Examples D1-D5, wherein the second signaling is one of a download control information, DCI, signaling and medium access control, MAC, control element, CE, signaling.

Example D7. The method of Example D6, wherein the DCI signaling includes at least one of an application delay and a validity timer.

Example D8. The method of any one of Examples D1-D7, wherein the omitting comprises omitting sampling CSI-RS symbols associated with the second set of ports.

Example D9. The method of any one of Examples D1-D8, wherein the method further includes:
when a muting pattern leads to at least one empty resource element, transmitting, to the WD 22, a resource element indication indicating the at least one empty resource element is usable for at least one purpose.

Example D10. The method of Example D9, wherein the at least one purpose may be at least one of a data reception, interference measurements, an inaction.

Example D11. The method of any one of Examples D9 and D10, wherein the resource element indication is preconfigured by higher layer signaling.

Example D12. The method of any one of Examples D9-D11, wherein the resource element indication is dynamic and included in one of a muting command and a skipping command.

Example D13. The method of any Example D12, wherein the resource element indication is one of one-shot, configured with a pattern, and usable until one port is unmuted.

Example D14. The method of any one of Examples D9-D13, wherein the at least one purpose is specified per muted port.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device, WD, configured to communicate with a network node, the WD comprising processing circuitry configured to:
receive a first signaling from the network node, the first signaling including a first channel state information reference signal, CSI-RS, measurement configuration, the first CSI-RS measurement configuration indicating a first plurality of ports to measure;
receive a second signaling from the network node, the second signaling including a CSI-RS port muting pattern indication indicating a modified CSI-RS measurement configuration muting at least one muted port of the first plurality of ports; and
perform at least one CSI-RS measurement on at least one port of the first plurality of ports using the modified CSI-RS measurement configuration and omitting measurements on the at least one muted port.

2.-24. (canceled)

25. A method implemented in a wireless device, WD, configured to communicate with a network node, the method comprising:
receiving a first signaling from the network node, the first signaling including a first channel state information reference signal, CSI-RS, measurement configuration, the first CSI-RS measurement configuration indicating a first plurality of ports to measure;
receiving a second signaling from the network node, the second signaling including a CSI-RS port muting pattern indication indicating a modified CSI-RS measurement configuration muting at least one muted port of the first plurality of ports; and
performing at least one CSI-RS measurement on at least one port of the first plurality of ports using the modified CSI-RS measurement configuration and omitting measurements on the at least one muted port.

26. The method of claim 25, wherein the method further comprises determining the modified CSI-RS measurement configuration based on the CSI-RS port muting pattern indication.

27. The method of claim 25, wherein the method further comprises:
receiving correlation information indicating that a first plurality of CSI-RS measurements associated with the first CSI-RS measurement configuration is not correlated in time with a second plurality of CSI-RS measurements associated with the modified CSI-RS measurement configuration, the correlation information being received in one of:
the first signaling;
the second signaling; and
at least one additional signaling from the network node.

28. The method of claim 25, wherein method further comprises receiving a third signaling including a first list of CSI-RS port muting options; and
the CSI-RS port muting pattern indication including an index value corresponding to one of the first list of CSI-RS port muting options.

29. (canceled)

30. The method of claim 25, wherein the method further comprises:
determining a muted port estimate; and
transmitting, to the network node, a third signaling including an indication of the muted port estimate.

31. The method of claim 30, wherein the method further comprises receiving the CSI-RS port muting pattern indication from the network node in response to the transmission of the indication of the muted port estimate; and
interpreting the CSI-RS port muting pattern indication from the network node as an implicit indication of a confirmation of the muted port estimate.

32. (canceled)

33. (canceled)

34. The method of claim 25, wherein the second signaling is one of a downlink control information, DCI, signaling and medium access control, MAC, control element, CE, signaling, and wherein the DCI signaling includes at least one of an application delay and a validity timer.

35. (canceled)

36. The method of claim 25, wherein the omitting comprises omitting sampling of CSI-RS symbols associated with the at least one muted port.

37. The method of claim 25, wherein the first CSI-RS measurement configuration configures a first plurality of resource elements for measurements; and
the method further comprising determining at least one empty resource element of the first plurality of resource elements based on the CSI-RS port muting pattern indication.

38. The method of claim 37, wherein:
the method further comprises receiving, from the network node, a resource element indication indicating the at least one empty resource element is usable for at least one of:
a data reception;
inter-cell interference measurements; and
an inaction; and
wherein the resource element indication is one of:
statically preconfigured by higher layer signaling;
dynamically indicated in one of a muting command and a skipping command;
associated with a single slot; and
associated with a periodic pattern of slots.

39. (canceled)

40. (canceled)

41. The method of claim 38, wherein the method further comprises:
receiving a deactivation indication; and
deactivating the resource element indication responsive to receiving the deactivation indication.

42. The method of claim 38, wherein the method further comprises entering a sleep state during a first complete symbol period based on:
the at least one empty resource element corresponding to the first complete symbol period; and
the resource element indication indicating the at least one empty resource element is usable for an inaction during the first complete symbol period.

43. The method of claim 42, wherein the method further comprises:
determining a data reception configuration for the at least one empty resource element based on the resource element indication indicating the at least one empty resource element is usable for data reception during the first complete symbol period.

44. The method of claim 25, wherein the method further comprises transmitting a fourth signaling to the network node indicating a request for a different CSI-RS muting pattern based on an uplink buffer state of the WD.

45. The method of claim 25, wherein the method further comprises resetting at least one channel estimation filter for the first plurality of ports responsive to receiving the CSI-RS port muting pattern indication.

46. The method of claim 25, wherein the CSI-RS port muting pattern indication indicates a transmission configuration indicator (TCI) state; and
the at least one muted port being associated with the TCI state.

47. The method of claim 25, wherein the method further comprises autonomously adjusting at least one parameter of the first CSI-RS measurement configuration for the modified CSI-RS measurement based on a number of muted ports indicated by the CSI-RS port muting pattern indication being less than a number of ports configured for the first CSI-RS measurement configuration, wherein autonomously adjusting the at least one parameter includes adjusting a first number of symbols configured for the first CSI-RS measurement configuration to a second number of symbols configured for the modified CSI-RS measurement configuration, the second number of symbols being less than the first number of symbols.

48. (canceled)

49. A network node configured to communicate with a wireless device, WD, the network node comprising processing circuitry configured to:
cause transmission of a first signaling to the WD, the first signaling including a first channel state information reference signal, CSI-RS, measurement configuration, the first CSI-RS measurement configuration indicating a first plurality of ports to measure;
cause transmission of a second signaling to the WD, the second signaling including a CSI-RS port muting pattern indication muting at least one muted port of the first plurality of ports and enabling the WD to utilize a modified CSI-RS measurement configuration for feedback reporting; and
receive, from the WD, at least one CSI-RS measurement report for at least one CSI-RS measurement on at least one port of the plurality of ports using the modified CSI-RS measurement configuration and omitting measurements on the at least one muted port.

50.-72. (canceled)

73. A method implemented in a network node configured to communicate with a wireless device, WD, the method comprising:
transmitting a first signaling to the WD, the first signaling including a first channel state information reference signal, CSI-RS, measurement configuration, the first CSI-RS measurement configuration indicating a first plurality of ports to measure;
transmitting a second signaling to the WD, the second signaling including a CSI-RS port muting pattern indication muting at least one muted port of the first plurality of ports and enabling the WD to utilize a modified CSI-RS measurement configuration for feedback reporting; and
receiving, from the WD, at least one CSI-RS measurement report for at least one CSI-RS measurement on at least one port of the plurality of ports using the modified CSI-RS measurement configuration and omitting measurements on the at least one muted port.

74.-96. (canceled)
